(19) United States
(12) Patent Application Publication
(10) Pub. No.: US 2011/0170812 A1
(43) Pub. Date: Jul. 14, 2011

(54) SLIDE APPARATUS, TILTING MECHANISM AND SLIDE TYPE EQUIPMENT USING THE SAME

(76) Inventor: Han Sang Lee, Seoul (KR)

(21) Appl. No.: 13/119,984

(22) PCT Filed: Sep. 18, 2009
(86) PCT No.: PCT/KR2009/005337

§ 371 Date: Mar. 21, 2011

(30) Foreign Application Priority Data
Sep. 23, 2008 (KR) 10-2008-0093169

(51) Int. Cl. F16C 17/00; F16C 29/12

(52) U.S. Cl. 384/26; 384/40

(57) ABSTRACT

Disclosed is a slide apparatus for a personal portable terminal having a first body and a second body which is slidably displaceable on the first body. The slide apparatus includes a guide member on which at least a pair of guiding parts are spaced apart from each other; and a slide member having at least a pair of guided parts coupled with the respective guiding parts so as not to be derailed in a direction perpendicular to the guide member and displaceable along the same, wherein the slide member is displaceable along the guide member, and wherein the guiding part includes guide surfaces for guiding the opposite sides of the guided part.

### TECHNICAL FIELD

The present invention relates to a slide apparatus, a tilting mechanism, and slide type equipment using the same, and more particularly to a slide apparatus and a tilting mechanism capable of being applied to a personal portable terminal having a first body and a second body slidably displaceable on the first body, and slide type equipment such as a slide type portable terminal or the like using the slide apparatus and the tilting mechanism.

### BACKGROUND ART

In general, a portable terminal refers to a personal portable terminal, such as a personal digital assistant (PDA), a mobile phone, an electronic calculator, a portable game machine, a laptop computer, or a digital dictionary, which allows a user to enjoy communicating, gaming, web surfing, watching television, or calculating work while carrying it. Such a personal portable terminal is generally classified into slide type equipment and folder type equipment depending on the method of opening and closing the body thereof. The present invention relates to slide type equipment.

Typically, slide type equipment includes a first body having buttons thereon and a second body having a display, wherein the second body is designed to be slidably displaceable on the first body while maintaining a parallel contact to each other. A conventional slide apparatus employed in such slide type equipment will be described with reference to FIG. 1.

FIG. 1 is a cross-sectional view of a conventional slide apparatus.

As shown in the drawing, the conventional slide apparatus 10 includes a guide member 11 having a pair of guiding parts 12 on the opposite sides thereof, and a slide member 16 having a pair of guided parts 17 each coupled with the respective guiding parts 12 and capable of moving along the guiding parts 12. A space is provided between the bottom surface of guide member 11 and the bottom surface of the slide member 16, in which accessory components such as a spring or the like for moving the slide member 16 may be installed in the space.

### DISCLOSURE OF INVENTION

### Technical Problem

Inventors have found that the conventional slide apparatus 10 shown in FIG. 1 has drawbacks as follows:

(i) When an external force is exerted on the slide member 16 in a transverse, i.e., widthwise direction, the guiding parts 12 may be easily damaged since only one side of the guiding parts 12 supports the slide member 16.

(ii) In case of equipment like a portable game machine having a large width, which is usually grasped by the user with both hands, the slide member 16 is largely swayed in a widthwise direction even if a small gap is created between the guiding part and the guided part. The reason is because the engaging surface between the guiding part and the guided part is short, which makes the equipment vulnerable against impacts in the widthwise direction.

(iii) Since the second body which is slidably openable is not provided with a tilting function, the user has to bend his or her head or place the equipment in the upright position while playing a game. Furthermore, it is inconvenient for the user to watch television or see a movie while placing the equipment on an object like a desk or the like.

(iv) In the slide type equipment, there needs to be installed a torsion spring or the like for tiling the second body between the first body and the second body in order to assure that the second body, which is already slid against the first body, should be obliquely erected at a predetermined angle by the elastic force after the second body is slidably displaced parallel to the first body. However, in the slide type equipment with such constructions, even while the second body is slidably displaced on the first body in parallel to the latter, scratches may be created or large friction forces may be created between the contact areas due to a rotational torque provided by a hinge spring or the like between the second body and portions for guiding the second body.

In view of the above-noted drawbacks and other problems inherent in the prior art, it is an object of the present invention to provide a slide apparatus capable of reducing a sway in the widthwise direction of a member to be slidably displaced for equipment with a relatively large width as compared to the length thereof.

It is another object of the present invention to provide a slide apparatus that enables a second body to be tilted at a predetermined angle after slidably opening.

It is a further object of the present invention to provide a slide apparatus that enables a guide member and a slide member to be folded or tilted depending on the sliding position of the slide member.

It is a still further object of the present invention to provide a slide apparatus with a tilting function that can perform a smooth sliding operation.

It is a still further object of the present invention to provide a slide apparatus capable of adjusting the tilting angle of a guide member or the like.

It is a still further object of the present invention to provide a slide apparatus that can maintain a stable tilting posture in a state where a guide member or a second body has been tilted.

It is a still further object of the present invention to provide a slide apparatus that enables one end of a guide member or a second body to be displaced forward in a tilted state, thereby making efficient use of its space.

It is a still further object of the present invention to provide a tilting mechanism that can be suitably applied for the slide apparatus.

It is a still further object of the present invention to provide slide type equipment capable of adopting the tilting mechanism thereto.

### Technical Solution

In accordance with the present invention, there is provided a slide apparatus, including: a guide member on which at least a pair of guiding parts are spaced apart from each other; and a slide member having at least a pair of guided parts coupled with the respective guiding parts so as not to be derailed in a direction perpendicular to the guide member and displaceable along the same, wherein the slide member is displaceable along the guide member, and wherein the guiding part includes guide surfaces for guiding the opposite sides of the guided part.

Preferably, the guiding part is formed of a T-shaped protrusion, and the guided part is in the form of a T-shaped groove. In the alternative, the guiding part may be formed of a T-shaped groove, while the guided part is in the form of a T-shaped protrusion.

The T-shaped groove may be formed by attaching a member having a U-shaped cross-section with a member having a slot, wherein the U-shaped member has a larger width than that of the slot.

Alternatively, the guiding part is formed of an L-shaped protrusion and the guided part is in the form of an L-shaped groove, or the guiding part is formed of an L-shaped groove and the guided part is in the form of an L-shaped protrusion.

The L-shaped groove may be formed by attaching a member having a U-shaped bent part along its edge with a member having a straight rail along its edge. In the alternative, the L-shaped groove may be formed by attaching a member having a straight rail with the body of equipment having a groove.

It is preferable that the guiding part or the guided part may be formed by applying a synthetic resin onto the surface of a metallic skeleton.

The guiding part may have a different height in a longitudinal direction, respectively. And preferably, the slide member may be formed in a curved shape in a longitudinal direction.

Alternatively, the guide member is formed with a guide protrusion between the opposite guiding parts. It is preferable that the slide member is formed with an elongated hole in which the guide protrusion is inserted and guided in a longitudinal direction.

The guide protrusion projects in the other side of the guide member through the elongated hole, and a link plate is installed on the guide protrusion. One end of an elastic mechanism is pivotably connected to the link plate, and the other end of an elastic mechanism is pivotably supported at one side of the slide member.

The guide protrusion projects in the other side of the guide member through the elongated hole, and the link plate is installed on the guide protrusion. An aperture is formed at one side of the elongated hole, a guide rail is formed along the edge of the aperture, and a door member having a guided part along its opposite edges is movably installed in a longitudinal direction on the guide rail. The link plate and the door member are connected to each other through a specific member, so that the door member is displaceable in a longitudinal direction along the guide rail as the slide member moves in a longitudinal direction.

The guiding part or guided part may be formed with a protrusion in order to reduce the contact area therebetween. It is preferable to provide a tilting mechanism connected with the guide member for obliquely erecting or tilting the guide member depending on the position of the slide member.

The tilting mechanism includes the tilting mechanism includes at least a pair of tilting guided parts spaced apart from each other formed at the guide member; and a tilting guide member having at least a pair of tilting guiding parts spaced apart from each other and directly or indirectly connected with the pair of tilting guided parts, wherein the tilting guiding parts are designed to guide the pair of tilting guided parts, which allows the guide member to be pivoted and tilted.

The tilting guided part is formed of a shaft or a groove, and the tilting guiding part is in the form of a groove or a shaft for guiding the pivotal or displaceable movement of the tilting guided part depending on the tilting operation of the guide member.

The tilting guiding part or tilting guided part, which is composed of at least one groove, may be longer in its length than the diameter or thickness of the shaft-shaped tilting guided part or tilting guiding part.

Preferably, one or more ridges, with which the shaft-shaped tilting guiding part or tilting guided part can be coupled at a constant tilting angle, may be formed on the inner surface of the tilting guiding part or tilting guided part which is composed of a groove.

The tilting mechanism further includes a link member which indirectly connects the guide member with the tilting guiding part.

One end of the link member is pivotably connected with the guide member, and the other end of the link member is pivotably connected with the tilting guide member. At least one of the connecting portions between the guide member and the link member or between the link member and the tilting guide member may be connected with each other so as to be displaceable in a predetermined distance.

It is preferable to further include an elastic mechanism to bias the slide member in a forward or rearward direction according to a position of the slide member, in which one end of the elastic mechanism is pivotably connected with the guide member, while the other end of the elastic mechanism is pivotably connected with the slide member.

The tilting mechanism in accordance with the present invention includes a tilting guide member having the tilting mechanism includes at least a pair of tilting guided parts spaced apart from each other formed at a member for tilting; and a tilting guide member having at least a pair of tilting guiding parts spaced apart from each other and directly or indirectly connected with the pair of tilting guided parts, wherein the tilting guiding parts are designed to guide the pair of tilting guided parts, which makes the member to be tilted capable of being pivoted and tilted.

The tilting guided part is formed of a shaft or a groove, and the tilting guiding part is a groove or a shaft for guiding the pivotal or displaceable movement of the tilting guided part depending on the tilting operation of the member to be tilted.

A groove consisting of at least one of the tilting guiding part or tilting guided part has a construction including a greater length than the diameter or thickness of the shaft-shaped tilting guided part or tilting guiding part.

Preferably, one of the grooves consisting of the tilting guided part or tilting guiding part may be formed of a circular groove which supports the shaft-shaped tilting guided part or tilting guiding part to be pivoted about the same, and the other groove may be an elongated arc groove which is formed along the arc centered at the circular groove.

In the alternative, both grooves, which consist of the tilting guiding part or tilting guided part, may have a greater length than the diameter or thickness of the shaft-shaped tilting guided part or tilting guiding part so that both the shaft-shaped tilting guided part or tilting guiding part can be moved and tilted accordingly.

Preferably, one or more ridges, with which the shaft-shaped tilting guided part or tilting guiding part can be coupled at a constant tilting angle, may be formed in the inner surface of the groove consisting of the tilting guided part or tilting guiding part.

The tilting mechanism further includes a link member for indirectly connecting the member to be tilted with the tilting guiding part.

One end of the link member is pivotably connected with the member to be tilted, and the other end of the link member is pivotably connected with the tilting guide member. At least one of the connecting portions between the member to be tilted and the link member or between the link member and the tilting guide member may be connected with each other so as to be displaceable in a predetermined distance.

The tilting mechanism further includes an elastic member for providing an elastic force in such a direction that one end of the link member is to be erected. The elastic member may be installed at least one or between two of the member for tilting, tilting guide member, link member and the shafts pivotably supporting thereof, thereby applying an elastic force in such a direction as to tilt the member for tilting.

The member for tilting is provided with a lift prohibiting member at the rear lower portion thereof. The tilting guide member is formed with a lift prohibiting guide part which is coupled with the lift prohibiting member and allows the latter to be displaceable in a longitudinal direction. The rear end of the member for tilting is displaced in a forward direction to cause the guide member to be tilted and keep the rear end of the member for tilting from being lifted over a predetermined height.

It is preferable that the tilting guide member is provided with a ridge for adjusting the tilting angle of the member for tilting at one side of the tilting guide member in the moving path of the lift prohibiting member, wherein one side of the lift prohibiting member is engaged with the ridge.

The slide apparatus in accordance with the present invention includes a guide member having a guiding part, a slide member having a guided part coupled with the guiding part so as not to be derailed in a direction perpendicular to the guiding part and displaceable along the same, wherein the slide member is capable of moving along the guiding part, and the tilting mechanism which is connected with the guide member for folding or tilting the guide member.

The slide type equipment in accordance with the present invention includes, a first body, a second body, and the slide apparatus, in which one side of the slide apparatus is connected with the first body, and the other side of the slide apparatus is connected with the second body, thereby making it possible to slidably open and close the second body with respect to the first body.

### ADVANTAGEOUS EFFECTS

Advantageous Effects

The slide apparatus and slide type equipment according to the present invention are advantageous in that they are stable in use because of less sway in a widthwise direction on the slide member, and are not fragile due to a strength against a lateral impact.

The slide apparatus and slide type equipment in accordance with the present invention have stable tilting postures since the link supports the rear surface of the member to be tilted.

The tilting mechanism is structurally simple and easy to manufacture and modify in various manners.

Furthermore, the slide apparatus in accordance with the present invention is particularly suitable for equipment with short length but large width due to a high utilization of space because the rear end of the member to be tilted is tilted while moving forward.

Besides, the slide apparatus can adjust the tilting angle of the member to be tilted such as the guide member or the like.

The tilting mechanism in accordance with the present invention is stable in use because it supports the rear surface of the member to be tilted while the link is erected, and its tilting angle can be adjusted. The tilting mechanism may be constructed in various ways depending upon the construction of the connecting portion with the link, and also has excellent utilization of space since the one end of the member to be tilted can be pivoted while moving.

### BRIEF DESCRIPTION OF DRAWINGS

The foregoing and other objects, features and advantages of the present invention will become more apparent from the following detailed description when taken in conjunction with the accompanying drawings in which:

FIG. 1 is a cross-sectional view of a conventional slide apparatus;

FIG. 2 is a perspective view of slide type equipment in accordance with an embodiment of the present invention;

FIG. 3 is a perspective view illustrating the slide type equipment of FIG. 2 in a state in which its second body is tilted after slidably opening;

FIG. 4 is an exploded perspective view of the slide type equipment employed with the slide apparatus in accordance with the present invention;

FIG. 5 is an exploded perspective bottom view of the slide type equipment of FIG. 4;

FIG. 6 is an enlarged separated perspective view illustrating the coupling relationship between the guide member, the link and the tilting guide member;

FIG. 7 is a perspective bottom view illustrating the installation state of the elastic member;

FIGS. 8 through 13 are drawings illustrating the operational procedure of the components relating to the tilting mechanism and the locking member which is operated in accordance with the sliding position of the slide member, respectively;

FIGS. 14 through 16 are perspective views illustrating the tilted state of the slide member in a first through third stage after the locking member is released, respectively;

FIG. 17 is an exploded perspective view illustrating another embodiment of the tilting mechanism;

FIG. 18 is a bottom view of FIG. 17;

FIG. 19 is an exploded perspective view illustrating another embodiment of the tilting mechanism in accordance with the present invention;

FIG. 20 is an exploded perspective view of the slide apparatus illustrating another embodiment of the T-shaped guiding part and the guided part;

FIG. 21 is a perspective bottom view of FIG. 20;

FIG. 22 is a perspective view illustrating the assembled state of the guide member and the slide member;

FIG. 23 is a separated perspective view illustrating the manufacturing method of the guide member;

FIG. 24 is a separated perspective view illustrating another embodiment of the slide type equipment in accordance with the present invention;

FIG. 25 is a perspective bottom view of FIG. 24;

FIG. 26 is an exploded perspective of the slide type equipment of FIG. 24;

FIG. 27 is a perspective bottom view of FIG. 26.

FIG. 28 a perspective view illustrating the closed state of the slide type equipment of FIG. 24;

FIG. 29 is a perspective view illustrating the state in which the second body of the slide type equipment of FIG. 28 is open;

FIG. 30 is a partial sectional view illustrating the assembled state of the slide type apparatus in accordance with another embodiment of the present invention;

FIG. 31 is a separated perspective view illustrating another embodiment of the slide apparatus in accordance with the present invention;

FIG. 32 is a separated perspective bottom view of FIG. 31;

FIG. 33 is a perspective view illustrating the assembled state of the slide apparatus of FIG. 32.

FIG. 34 is a sectional view illustrating another embodiment of the guiding part and the guided part in accordance with the present invention;

FIG. 35 is an exploded perspective view illustrating another embodiment of the tilting mechanism in accordance with the present invention;

FIG. 36 is a side elevation view illustrating the assembled state of the tilting mechanism of FIG. 35;

FIG. 37 is a separated perspective view illustrating a modified embodiment of FIG. 35;

FIG. 38 is a separated perspective view illustrating another modified embodiment of FIG. 35;

FIGS. 39 through 41 are side elevation views illustrating a folded state, a first tilted state, and a second tilted state of the tilting mechanism shown in FIG. 38, respectively;

FIG. 42 is a separated perspective view illustrating still another embodiment of the tilting mechanism in accordance with the present invention;

FIG. 43 is a separated perspective view illustrating a modified embodiment of FIG. 38; and

FIG. 44 is a sectional view illustrating another modified embodiment of FIG. 38.

### BEST MODE FOR CARRYING OUT THE INVENTION

Hereinafter, preferred embodiments of the present invention will be described in detail with reference to the accompanying drawings.

FIG. 2 is a perspective view of the slide type equipment according to an embodiment of the present invention, and FIG. 3 is a perspective view showing the slide type equipment of FIG. 2 in a state in which the second body of the slide type equipment is tilted after slidably opening.

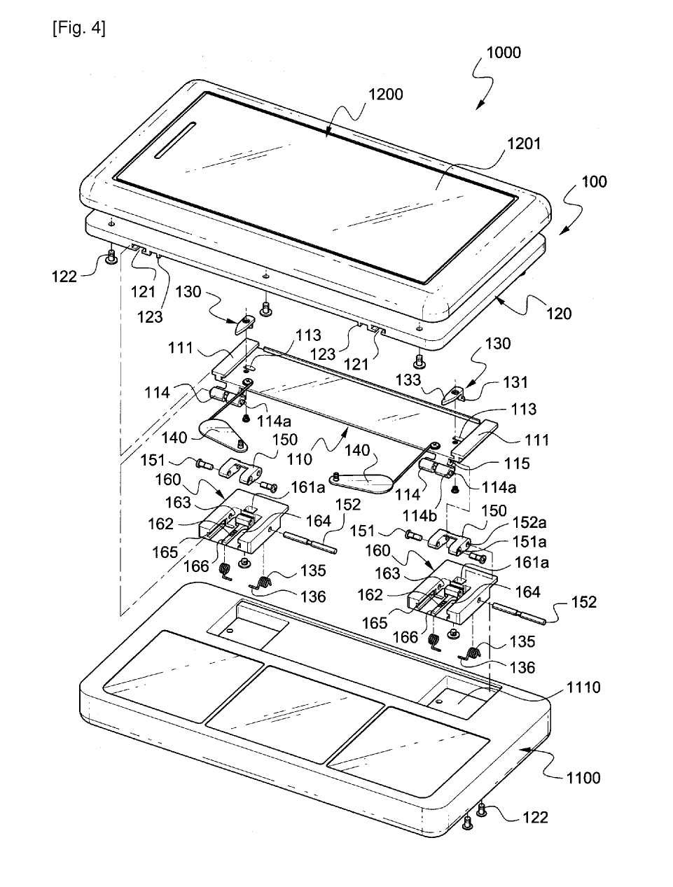

Referring to FIGS. 2 and 3, the slide type equipment 1000 includes a first body 1100 and a second body 1200 slidably displaceable back and forth on the first body 1100. The slide apparatus is interposed between the first body 1100 and the second body 1200, which will be described in more detail with reference to FIG. 4 and remaining drawings.

Equipment such as a portable game machine or the like, which typically has a width greater than its length, is designed to be grasped by the user with both hands while using the equipment. In such a case, it is convenient for the user to play the game with the equipment in which the second body 1200 having a display 1201 thereon is tilted at a predetermined angle.

The slide type equipment 1000, as shown in FIG. 3, allows the second body 1200 to be tilted at a predetermined angle after slidably moving forward. The slide type equipment may be configured in such a manner that the tilting angle of the second body 1200 can be adjusted in multiple steps as needed.

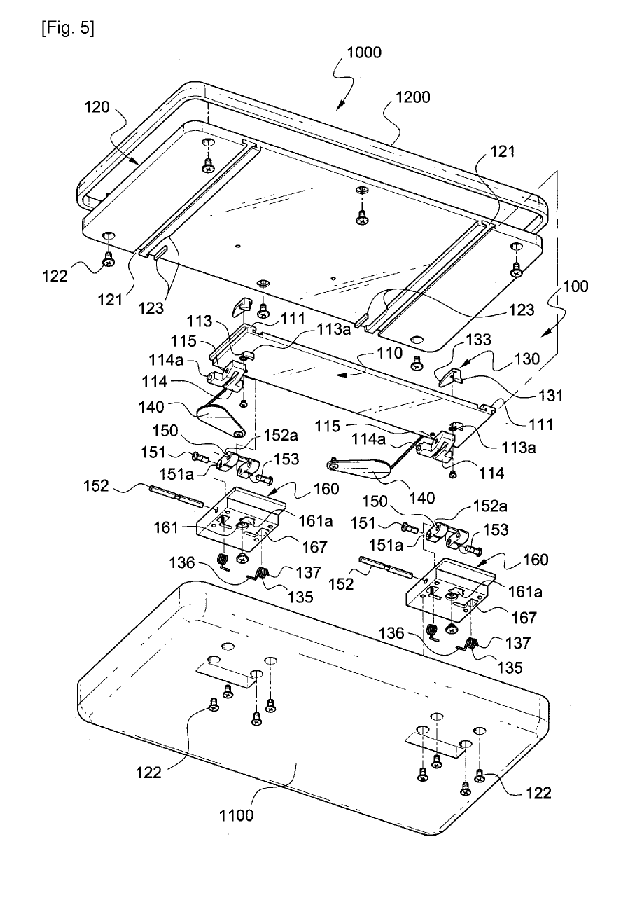

FIG. 4 is an exploded perspective view of slide type equipment employed with the slide apparatus, and FIG. 5 is an exploded perspective bottom view of the slide type equipment of FIG. 4, which is viewed from bottom to top in front of the slide type equipment.

As shown in the drawings, the slide type equipment 1000 includes a first body 1100, a second body 1200, and a slide apparatus 100 which is interposed between the two bodies so as to allow the second body 1200 to be slidably displaceable on the first body 1100. Typically, the first body 1100 contains a main substrate, a plurality of electronic components for performing various functions to be needed, a battery, and a plurality of buttons for key inputting, and the second body 1200 has a display 1201 for displaying an image thereon.

The first body 1100 is formed with a pair of mounting parts 1110 spaced apart from each other in the form of a groove for mounting tilting guide members 160.

The slide apparatus 100 installed between the first body 1100 and the second body 1200 includes a guide member 110. The guide member 110 is provided with a pair of guiding parts 111 spaced apart from each other. Each of the guiding parts 111 is formed of a protrusion with a T-shaped cross-section, whose length in a longitudinal direction is very short. Forming the guiding parts 111 in a T-shaped protrusion as above is intended to allow the guiding parts 111 to be received in the groove-shaped guided parts 121 and supported with their opposite lateral surfaces. In this case, there is no fear that any of the guiding parts 111 and the guided parts 121 will be damaged or fractured since one lateral surface of the left guiding part 111 and one lateral surface of the right guiding part 111 support the slide member 120 even if an external force is exerted on the slide member 120 in a widthwise, i.e., transverse direction. As such, it is a feature of the present invention that one of the guiding parts 111 and the guided parts 121 receives the other one, thereby supporting the other with its opposite lateral surfaces.

On the bottom surface of the guide member 110 between the two guiding parts 111, there are provided a pair of through-holes 113 adjacent to the guiding parts 111, respectively. The through-holes 113 are designed to ensure one of locking members 130 described below to be penetrated under the guide member 110. If an elastic member 135 for applying tilting force is provided on only one of the guide members 110, a single through-hole 113 may be formed at the corresponding position. In the alternative, if the tilting force is provided by any other component, no through-hole may be formed accordingly.

On the bottom surface of the guide member 110, there are provided a pair of protrusions 113a. Each of the protrusions 113a projects downward along the periphery of the through-hole 113. The protrusion 113a serves to guide the locking member 130 to be pivoted in a stable manner. In addition, when the protrusion 113a is inserted into holes 161a but not tilted, it prevents the guide member 110 from moving forward. Moreover, the protrusion 113a serves to keep the locking member 130 from making contact with the inner surface of the through-hole 113 to obstruct the pivot operation.

The slide apparatus 100 is provided with a slide member 120. The slide member 120 is attached to the bottom surface of the second body 1200 through screws 122 or the like. On the bottom surface of the slide member 120, there is provided a pair of guided parts 121 in the form of groove having a T-shaped cross-section, in which the guided parts spaced apart from each other extend transversely in the slide member 120. The guided parts 121 may take the shape of the guiding parts 111 described above, while the guiding parts 111 may take the shape of the guided parts 121 described above. As shown in the drawings, a swinging part 123 is formed adjacent to one end of the guided parts 121. The slide member 120 may be integrally formed at the bottom surface of the second body 1200.

Preferably, an elastic mechanism 140 for pushing the slide member in a longitudinal direction depending on the position of the slide member 120 is retained between the guide member 110 and the slide member 120. The elastic mechanism 140 preferably includes a torsion spring having a swirly wound part and an extended arm from one end of the wound part, and a casing for receiving the wound part, in which one end of the wound part is supported within the casing.

The slide apparatus 100 includes a locking member 130. Preferably, the locking member 130 is pivotably installed at one of the guide member 110 in the moving path of the slide member 120. The locking member 130 is pivoted by the slide member 120, which catches the guide member 110 depending on the position of the slide member 120 so that it prevents the guide member 110 from being tilted. Otherwise, the locking member 130 releases the guide member 110, which allows the latter to be tilted at a predetermined angle.

The locking member 130 includes a hook part 131 passed through a through-hole 113, in which the hook part 131 is hooked to or released from a hook ledge 161 depending on the pivot angle, and a swung part 133 disposed on the upper side of the guide member 110, in which the swung part 133 is hooked to or released from the swinging part 123 depending on the moving position of the slide member 120, thereby rendering the hook part 131 to be engaged with the hook ledge 161 or released therefrom. The locking member 130 may be provided at any other portion of the slide apparatus 100 and modified in various ways. For example, a lateral groove may be formed on the outer surface of the guiding part 111, and the locking member 130 may be provided at the first body 1100, in which the locking member 130 are operated to be hooked to or released from the lateral groove, so that the locking member 130 can catch or release the guide member 110 depending on the position of the slide member 120.

A pair of lift prohibiting members 114 is provided at the rear lower portion of the guide member 110, which are spaced apart from each other. The lift prohibiting member 114 has a pinhole 114b through which a pin 114a is inserted. The lift prohibiting member 114 protrudes backward beyond the rear end of the bottom surface of the guide member 110, and a portion of the central part of the lift prohibiting member 114 is formed of a cutout hinge. The pin 114a is inserted into the pinhole 114b to constitute a portion of the lift prohibiting member 114. The reason to form a cutout at the central part of the lift prohibiting member 114 is to expose the central part of the pin 114a, which allows the pin 114a to be hooked onto a protrusion 162 described below to adjust the tilting angle. Here, the pin 114a may be integrally formed with the lift prohibiting member 114.

Adjacent to the lift prohibiting member 114 there is provided a link connecting part 115 for pivotably connecting one end of a link 150, in which the link connecting part 115 is formed of a through-hole. An end of the link 150 is pivotably connected to the link connecting part 115 through a pin 151.

The link connecting part 115 and the lift prohibiting member 114 also serve as a tilting guide means, in which the guide member 110 is guided so as to be tilted while pivoting and moving in relation to the engaging portion between the link connecting part 115 and the lift prohibiting member 114.

The slide apparatus 100 includes U-shaped link 150. The link 150 is provided with a pair of pinholes 151a and 152a at the opposite ends thereof and also grooves 153 on the bottom central portion thereof to receive each arm 136 of an elastic member 135. The link 150 serves to indirectly connect the guide member 110 and tilting guide member 160.

The slide apparatus 100 includes a tilting guide member 160. Preferably, the tilting guide member may be preferably installed in the mounting groove 1110 formed on the first body 1100 through screws 122 or the like. In the alternative, the tilting guide member may be integrally formed with the first body 1100.

The tilting guide member 160 has a link supporting part 163 for pivotably supporting the other end of the link 150 which is mounted by means of a support pin 152. A hole 161a is formed in front of the link supporting part 163, and a hook ledge 161 is formed at the lower portion of the hole 161a. Accordingly, the hook part 131 of the locking member 130 can be hooked onto the hook ledge 161. The tilting guide member 160 is formed with a link operating groove 164 in which the link 150 and the lift prohibiting member 114 are operatively received. The opposite side walls of the link operating groove 164 are formed with a lift prohibiting guide part 165 in the form of a lateral groove. The opposite ends of the pin 114a, which constitutes the lift prohibiting member 114, may be movably inserted into the lift prohibiting guide parts 165, respectively. In addition, a series of protrusions 162 are provided on a linear ridge 166 formed at the central portion of the bottom surface of the tilting guide member 160, so that the tilting angle can be adjusted in multiple stages. Although the lift prohibiting guide part 165 is formed parallel to the bottom surface of the link operating groove 164 in the present embodiment, it is not necessarily to be parallel thereto. Alternatively, the lift prohibiting guide part 165 may be obliquely formed in its longitudinal direction, and further it may be formed along a curved line.

Here, the link supporting part 163 and the lift prohibiting guide part 165 serve as a tilting guide member, which guides the pivotal operation of the link 150 and the displaceable movement of the lift prohibiting member 114 in order to tilt the guide member 110.

In addition, the tilting guide member 160 is formed with at least one groove 167 for mounting the elastic member 135. The tilting guide member 160 is secured to the first body 1100 through screws 122. In the alternative, the tilting guide member 160 may be integrally formed with the first body 1100.

The slide apparatus 100 includes an elastic member 135, preferably in the form of a torsion spring. The elastic member 135 is retained at the outer surface of the support pin 152 through the groove 167. When installed, the elastic member 135 exerts an elastic force on the link 150 in an upward direction, in which the long arm 136 of the elastic member 135 bent in the widthwise direction of the link 150 is coupled with an engaging groove formed at the bottom surface of the link 150. In contrast, the short arm 137 of the elastic member 135 leans against the inner side wall of the groove 167 for mounting the elastic member 135. Such an elastic member 135 is designed to provide an elastic force to tilt the link 150 by applying the force to the link 150 in an upward direction. In the alternative, the elastic member 135 may be made in a different form only if it can apply an elastic force to the link 150, the guide member 110 or the slide member 120, in which the elastic member may be installed in the link 150, at the other position of the guide member 110 connected to the link 150, or between the first body 1100 and the slide member 120.

The link 150, the tilting guide member 160, and the locking member 130 described hereinabove constitute a tilting mechanism for tilting the guide member 110. If the user wants to manually operate the tilting mechanism, it is not necessary to provide the elastic member 135 such as the torsion spring or the like and the locking member 130 or the like. However, it is preferable to provide the elastic member 135 in the form of a torsion spring which exerts an elastic force enough to automatically tilt the guide member 110 or the like to a constant angle when the locking state of the locking member 130 is released.

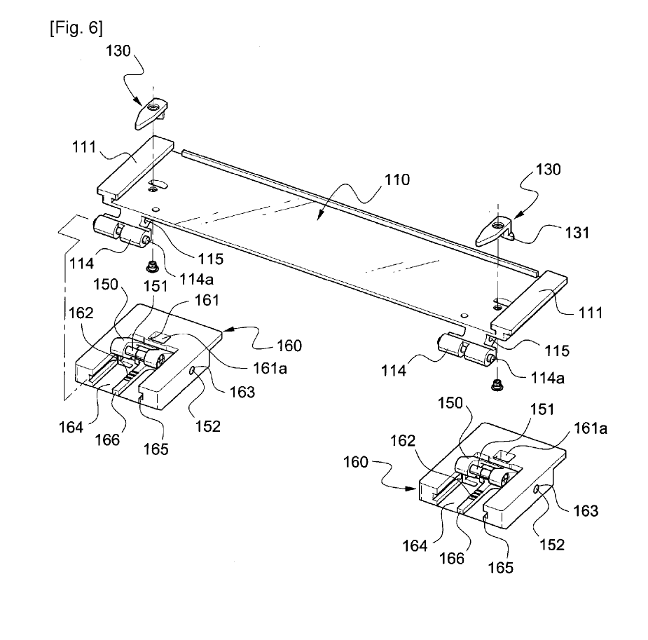

FIG. 6 is an enlarged separated perspective view illustrating the coupling relationship between the guide member, the link and the tilting guide member.

Referring to FIG. 6, one end of the link 150 is pivotably connected to the link connecting part 115 formed at the bottom surface of the guide member 110 by means of the pin 151, while the other end of the link 150 is pivotably supported to the link supporting part 163 of the tilting guide member 160. The link 150 serves to lift one portion of the guide member 110 while pivoting about the pin 152 of the link supporting part 163, when the force to prevent its rotation by the locking member 130 is released. The lift prohibiting member 114 formed in the guide member 110 is inserted into the lift prohibiting guide part 165 formed on the opposite side walls of the link operating groove 164. Then, the lift prohibiting member 114 prevents the rear end of the guide member 110 from being lifted, and it can be moved back and forth as well when the guide member 110 is tilted or returned to its initial position. A ridge 166 is formed at the intermediate portion of the opposite lift prohibiting guide parts 165, and a plurality of protrusions 162 are provided on the one side of the ridge 166 so as to adjust the tilting angle of the guide member 110 in multiple stages.

The hook part 131 of the locking member 130 is inserted in the hole 161a of the tilting guide member 160 after passing through the through-hole. The hook part 131 is engaged with the hook ledge 161 to hold the guide member 110 not to be tilted, or released from the hook ledge 161 to make the guide member 110 be tilted.

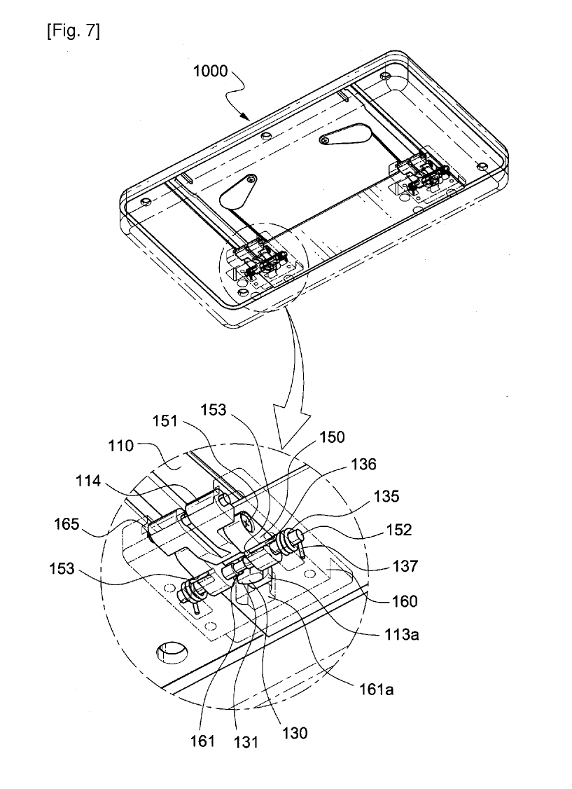

The installation state of the elastic member 135 for providing the elastic force to pivot the link 150 will be described with reference to FIG. 7.

FIG. 7 shows the installation state of the elastic member seen from the bottom.

Referring to FIGS. 5 and 7, the elastic member 135 installed in the slide type equipment 1000 is coupled with the outer surface of the support pin 152 which supports the other end of the link 150. One end of the elastic member 135, i.e., the short arm 137 leans against the inner side wall of the groove 167 for mounting the elastic member 135. The other end of the elastic member 135, i.e., the long arm 136 is bent in the widthwise direction of the link 150 to be coupled with the groove 153 formed at the bottom surface of the link 150, thereby applying the elastic force for tilting the guide member 110. In such a state, the protrusion 113a and the hook part 131 of the locking member 130 are received within the hole 161a, while hook part 131 is engaged with the hook ledge 161.

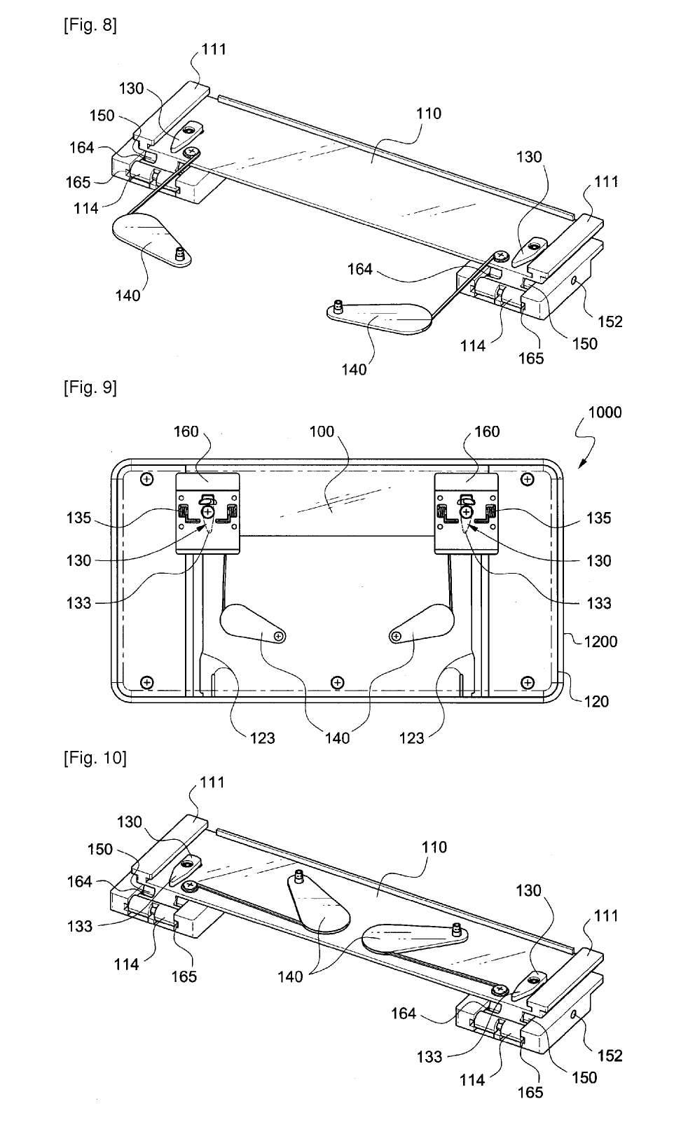

FIGS. 8 through 13 illustrate the operational procedure of the components relating to the tilting mechanism and the locking member which is operated in accordance with the sliding position of the slide member, respectively. FIGS. 8, 10 and 12 are exploded perspective views showing the operational procedures in the state of removing the first and second bodies and the slide member. FIGS. 9, 11, and 13 are bottom views showing the operational procedures of the slide type equipment in operation orders.

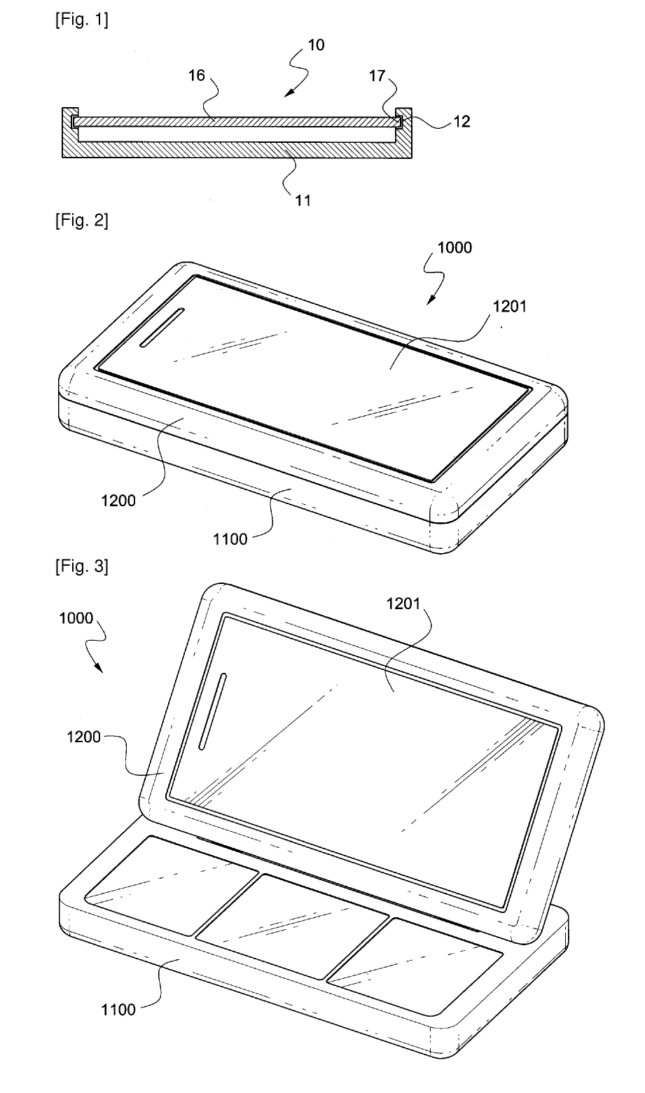

FIGS. 14 through 16 illustrate the tilted state of the slide member in a first through third stage after the locking member is released, respectively. The opening procedure of the slide apparatus will be described with reference to FIGS. 1 through 15 as follows:

FIG. 8 shows the slide type equipment 1000 in a closed state as shown in FIGS. 2 and 9. When the slide type equipment 1000 is in a closed state, one end of the elastic mechanism 140 is pivotably supported at the guide member 110, while the other end is pivotably supported at the slide member 120. Accordingly, the elastic force biases the slide member 120 in the rearward direction, i.e., toward the user, thereby maintaining the second body 1200 in a closed state. At this state, the locking member 130 maintains its locking state, in which the link 150 and lift prohibiting member 114 are received within the link operating groove 164 in a folded state.

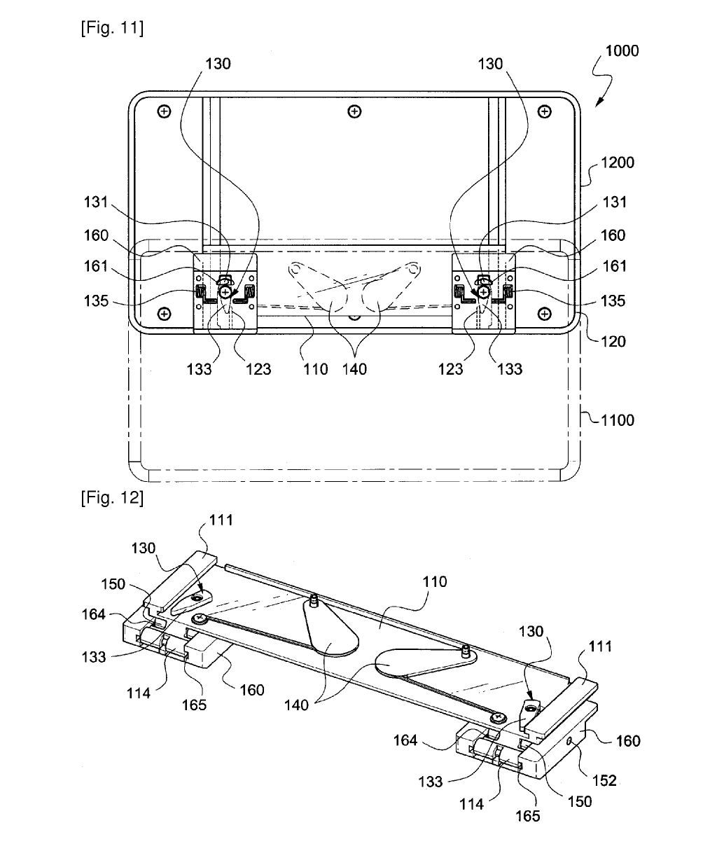

When the user pushes the second body 1200 in the forward, i.e., longitudinal direction from the state shown in FIGS. 8 and 9, the second body 1200 is moved forward along the guiding part 111. The elastic mechanism 140 is compressed to store the elastic force while the slide member 120 slidably moves forward. From the moment when the connecting portion of the elastic mechanism 140 to the slide member 120 passes beyond the connecting portion of the elastic mechanism 140 to the guide member 110, the elastic mechanism 140 is expanded to push the slide member 120 in the forward direction. With this procedure the slide member 120 continues to move until the swinging part 123 reaches the position of the swung part 133 of the locking member 130. Such a state is shown in FIGS. 10 and 11.

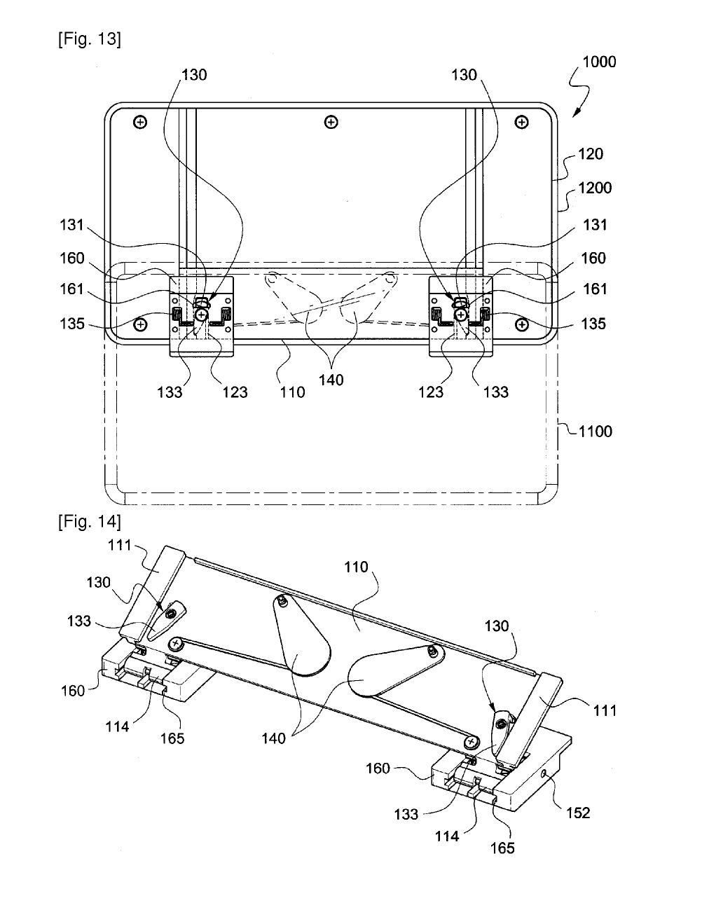

In the state shown in FIGS. 10 and 11, the swinging part 123 formed at the bottom surface of the guide member 110 comes in contact with the swung part 133 of the locking member 130. Here, if the slide member 120 moves further in the forward direction by the elastic force of the elastic mechanism 140, the swung part 133 engages with the swinging part 123, which causes the left locking member 130 to be pivoted clockwise and the right locking member 130 to be pivoted counterclockwise. Accordingly, the hook part 131 of the locking member 130 is released from the hook ledge 161 of the tilting guide member 160, thereby releasing the locking state. Such a state is shown in FIGS. 12 and 13.

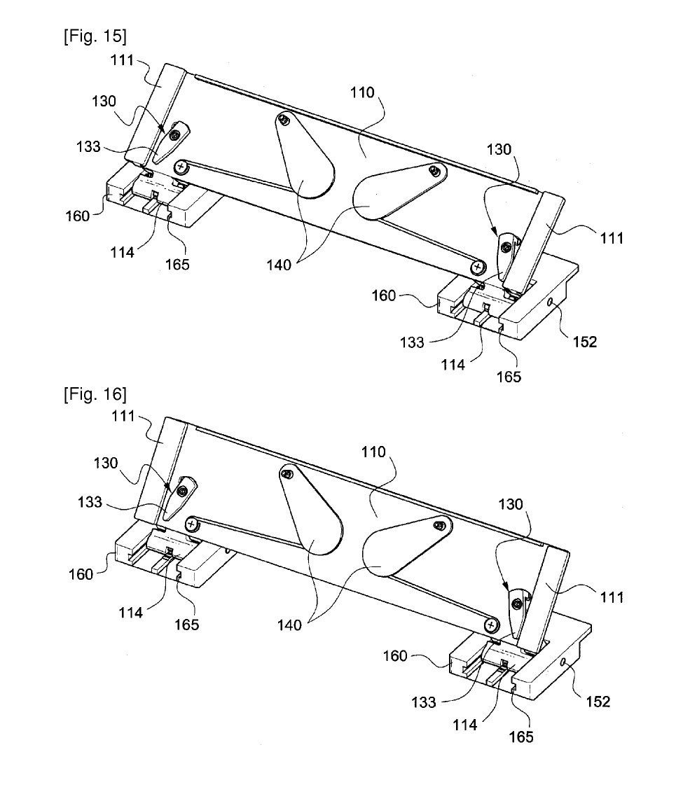

When the locking state due to the locking member 130 is released, the elastic member 135 lifts up one portion of the link 150. The link 150 then is pivoted about the pin 152 which supports the link 150 against the tilting guide member 160, thereby lifting the guide member 110 in the upward direction. Accordingly, the link 150, the guide member 110 and the slide member 120 begin to tilt in a unitary manner. The link 150 pulls the guide member 110 in the forward direction to lift up the connecting portion as the link 150 is pivoted. However, the lift prohibiting member 114 moves forward along the lift prohibiting guide part 165 and engages with the protrusion 162 to then stop its motion. Such a state is referred to as a first tilted state, as shown in FIG. 14. If the second body 1200 is lifted further upwardly from the state shown in FIG. 14, it can be further inclined in a second and third tilted state as shown in FIGS. 15 and 16, respectively.

As shown in FIGS. 14 through 16, when the user wants to fold the slide type equipment 1000 after using the same maintained in one of the first through third tilted states, he or she may retract the second body 1200 over a certain distance after pressing it down. The locking member 130 is then pivoted in the reverse direction by means of the swinging part 123 formed at the side wall of the guiding part 111, which causes the hook part 131 of the locking member 130 to be engaged with the hook ledge 161. If the second body 1200 is further retracted, the elastic mechanism 140 is expanded from the certain point so as to retract the guide member 110, the slide member 120 and the second body 1200 in a unitary manner, thereby returning them to the state shown in FIGS. 8 and 9.

As described hereinabove, it can be appreciated that the slide apparatus and the slide type equipment has a stable sliding operation due to less sway in a widthwise, i.e., transverse direction since the guiding part is provided at opposite sides and the guiding part and the guided part guide each other at both sides. Further, there is less fear of damage or fracture of the slide apparatus and the slide type equipment since they are supported by at least two points against lateral impacts exerted in the transverse direction.

In addition, it can be noted that the slide apparatus and the slide type equipment have a stable tilting posture since the link supports the rear surface of the member to be tilted. Furthermore, the slide apparatus and the slide type equipment in accordance with the present invention are suitable for equipment with short length but large width because of high utilization of their space since the rear end of the member to be tilted is pivoted while moving forward. Besides, the slide apparatus and the slide type equipment can adjust the tilting angle of the member to be tilted.

### MODE FOR THE INVENTION

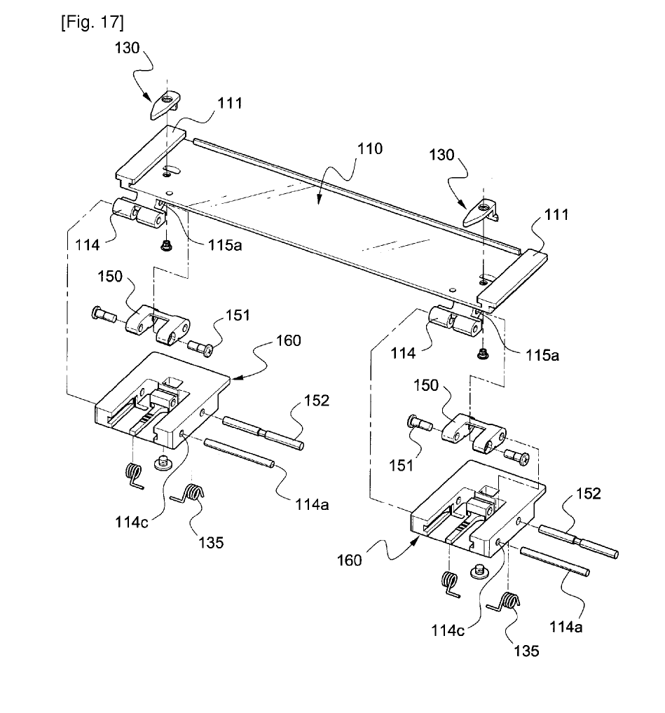

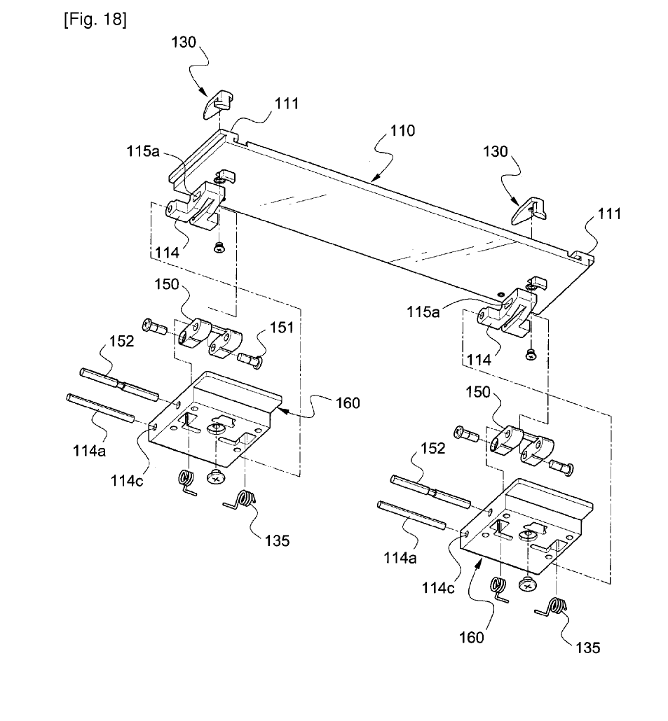

FIG. 17 shows another embodiment of the tilting mechanism, and FIG. 18 shows the tilting mechanism of FIG. 17 seen from the bottom.

The slide apparatus may be constructed in such a way that instead of pivotably securing the lift prohibiting part 114 to a hole 114c through a pin 114a, the link connecting part 115a may be extended to allow the pin 151 coupled therewith to be displaceable, and the other end of the link 150 may be pivotably coupled with the link support part 163. Accordingly, the link 150 is pivoted to lift the link connecting part 115a, and the guide member 110 acting as a tilting member is pivoted about the lift prohibiting member 114 to be tilted. Here, the tilting guide member 160 also serves as a supporting member for the lift prohibiting member 114. Protrusions for a multistaged tilting operation may be formed on the inner surface of the link connecting part 115a. Thus the remaining constructions of the slide apparatus shown in FIG. 17 are similar to those described hereinabove, and the detailed description thereof will be omitted.

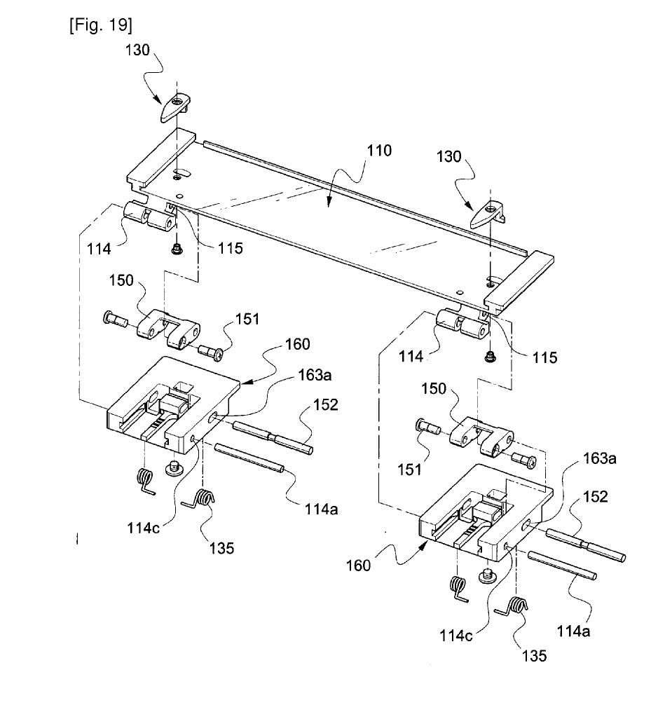

FIG. 19 shows another embodiment of the tilting mechanism in accordance with the present invention.

The link connecting part 115 may be constructed such that one end of the link 150 can be pivotably supported, while the link supporting part 163 to which the other end of the link 150 is connected can be elongated to allow the other end of the link 150 to be displaceable accordingly.

In the alternative, the tilting mechanism may be constructed to elongated the pinholes 151a and 152a formed at the link 150. Otherwise, the tilting mechanism may be constructed to include combinations of one or more constructions described above.

Embodiments described hereinabove illustrate an exemplary construction that the elastic member 135 for applying the tilting power is installed on the support pin 152 of the link supporting part 163. It can be noted that the elastic member 135 may be mounted on one or two of the link connecting part 115, the guide member 110, the tilting guide member 160 and any shaft for pivotably supporting them if it can provide an elastic force in such a direction to tilt the guide member. The reason is that the role of the elastic member 135 is just to apply an elastic force to the guide member 110 to be tilted, which makes it possible to automatically tilt the guide member 110.

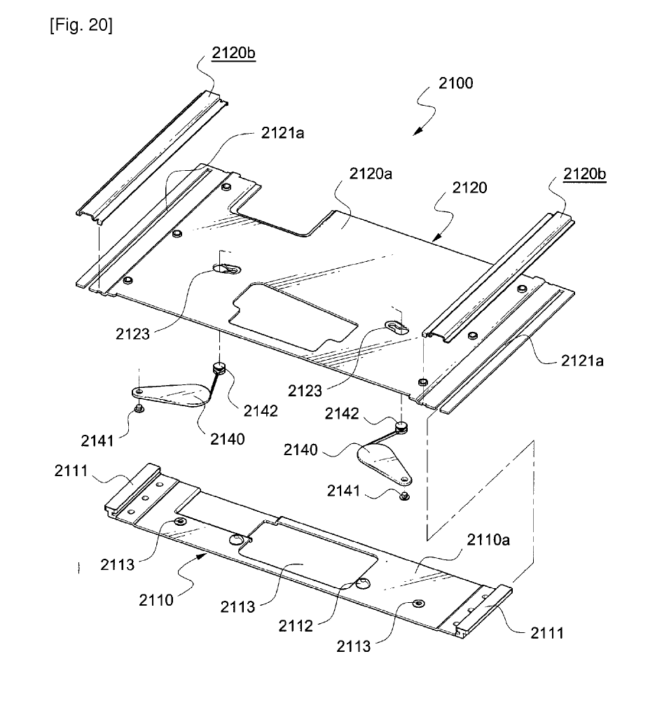

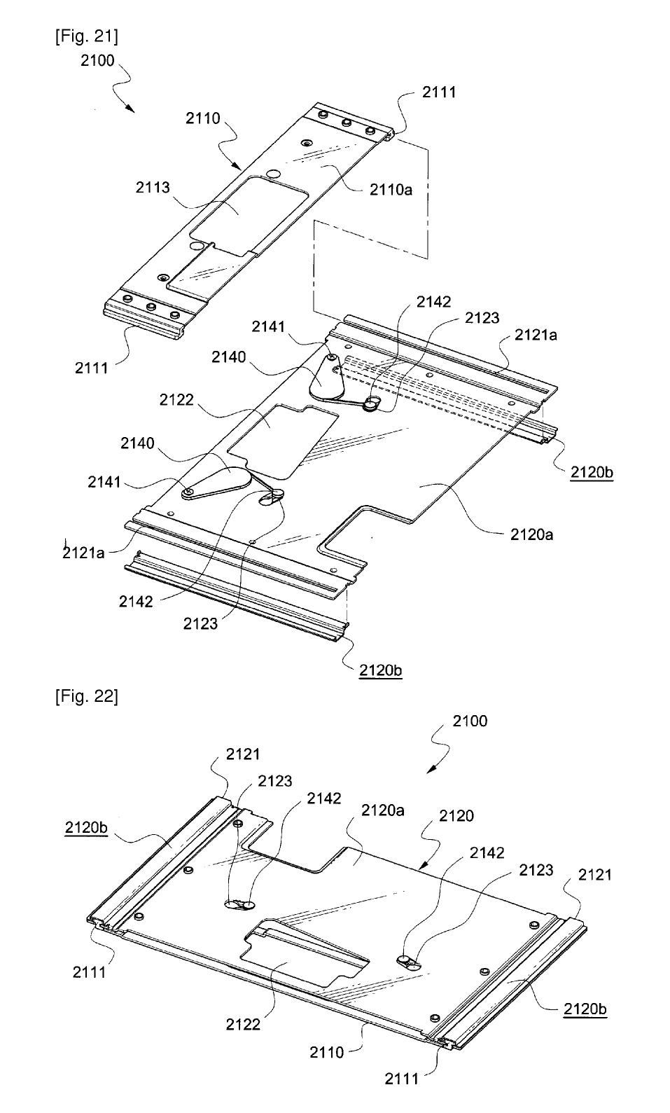

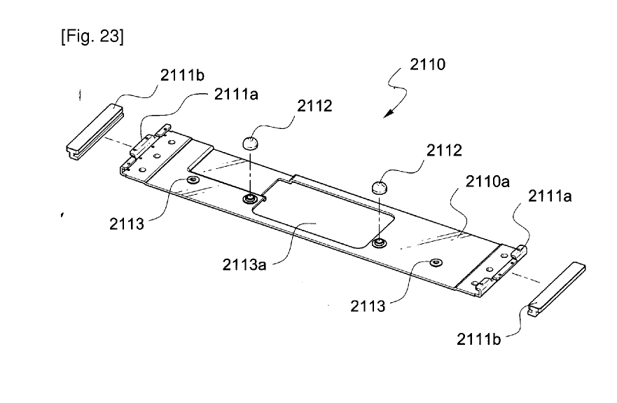

FIG. 20 is an exploded perspective view of the slide apparatus illustrating another embodiment of the T-shaped guiding part and the guided part. FIG. 21 is a perspective bottom view of FIG. 20, and FIG. 22 is a perspective view illustrating the assembled state of the guide member and the slide member. FIG. 23 illustrates the manufacturing method of the guide member.

It is desirable to manufacture a guiding part skeleton 2111a for a bottom part 2110a and a guiding part with a metal plate using a press machine or the like, and then to apply a synthetic resin 2111b to the guiding part skeleton 2111a by an insert injection molding to form the guiding part having a T-shaped cross-section. If a guide member 2110 has a large width, the guide member 2110 is preferably provided with a pair of support projections 2112 with a synthetic resin at the bottom part 2110a thereof, which support the central area of a slide member 2120 to prevent a deflection from occurring therein. The guide member 2110 is formed with an opening 2113a at the bottom part 2110a, which allows a flexible cable or the like to be passed through. Formed between the guiding part 2111 and the opening 2113a is a support hole 2113 to receive a rivet 2141 for pivotably supporting one end of an elastic mechanism 2140.

As shown in the drawing, the slide member 2120 includes a slide plate 2120a having an elongated slot 2121a along its opposite edges, and a plate cover 2120b encompassing the upper portion of the slot 2121a and being attached to the plate cover 2120b along the opposite sides of the slot 2121a to form a guided part 2121 with a T-shaped cross-section. The plate cover 2120b includes a reverse U-shaped cross-section part and a bent part, in which the bent part is crooked at both lower ends of the cross-section part to be attached to the slide plate 2120a. The plate cover 2120b is joined to the slide plate 2120a by a spot welding or the like.

The slide plate 2120a is formed with an opening 2122 to allow a flexible cable or the like to be passed through. A pair of support parts 2123 for receiving and pivotably supporting one end of an elastic mechanism 2140 is formed at opposite sides of the opening 2122, respectively. It is preferable to provide the support part 2123 with both a wide portion and a narrow portion in order to help the assembly of the hinge part 2142 of the elastic mechanism 2140 thereto with ease.

One end of the elastic mechanism 2140, as described above, is pivotably connected with the guide member 2110, while the other end is pivotably connected with the slide member 2120.

As to the guide member 2110 and the slide member 2120 as shown in FIGS. 20 through 23, they may be constructed as those in the above embodiments to be tilted by providing a lift prohibiting member and a locking member as well as by providing a link and a tilting guide member under the guide member 2110.

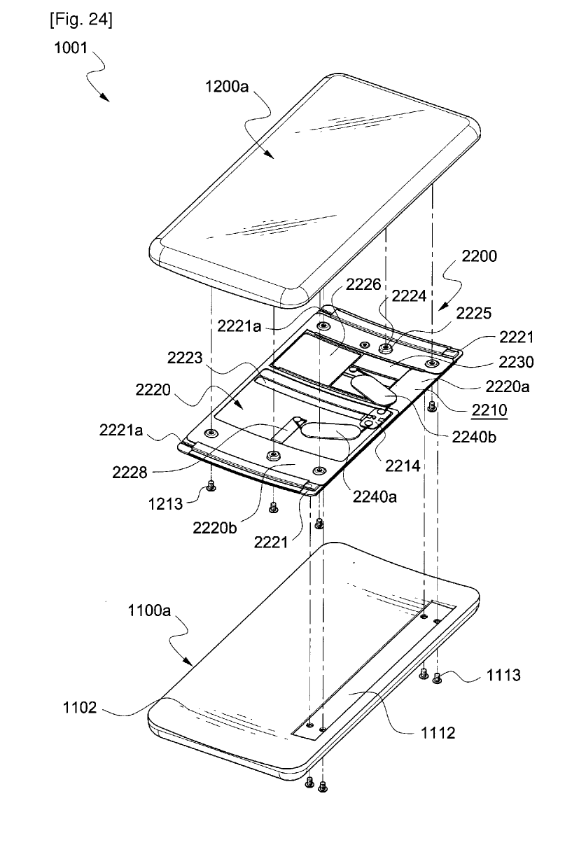

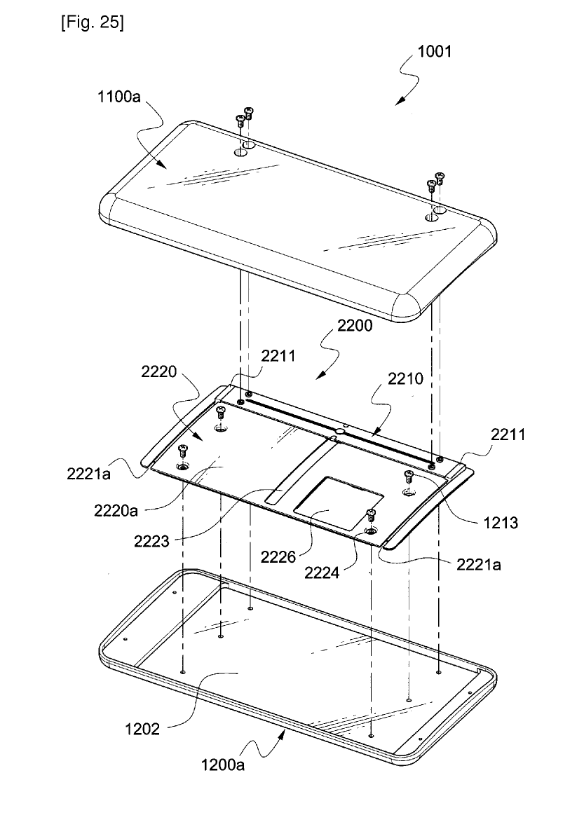

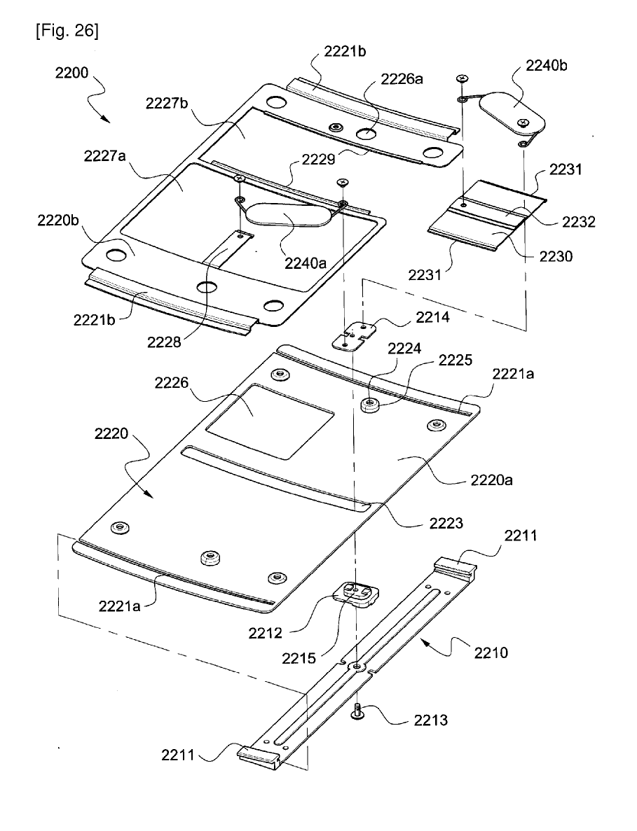

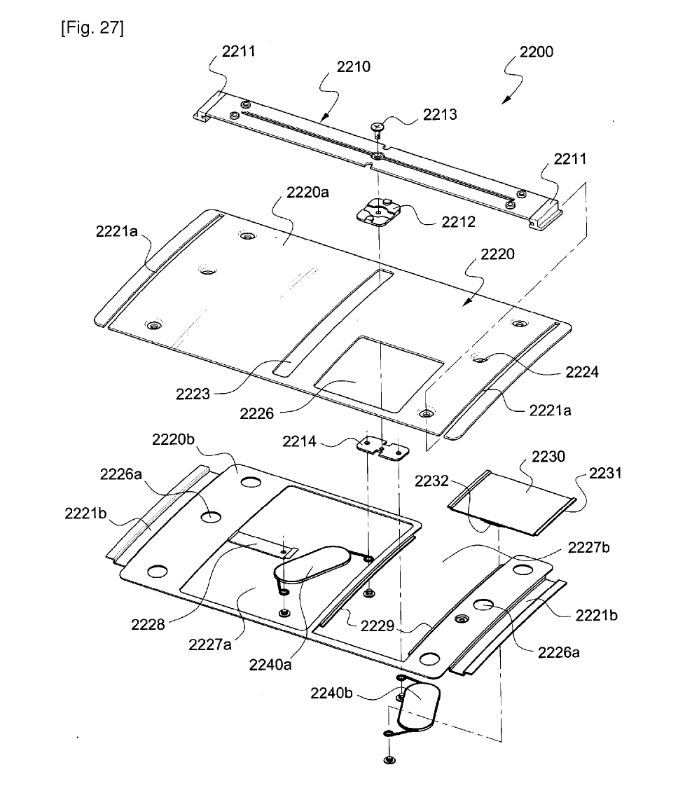

FIG. 24 is a perspective view illustrating another embodiment of the slide type equipment in a dissembled state in accordance with the present invention. FIG. 25 is a perspective bottom view of FIG. 24, and FIG. 26 is an exploded perspective of the slide type equipment of FIG. 24. FIG. 27 is a perspective bottom view of FIG. 26.

The slide type equipment 1001 shown in FIGS. 24 and 25 includes a first body 1100a whose upper surface is formed of a curved surface 1102. A groove 1112 for mounting a guide member is formed along the frontal edge of the first body 1100a. The groove 1112 has a greater depth in a front portion than in a rear portion.

The slide type equipment 1001 shown in FIGS. 24 and 25 includes a second body 1200a whose opposite bottom edges are formed of a curve. The second body 1200a is provided with a mounting part 1202 in the form of a groove at its bottom surface in order to mount the slide member 2220.

The slide type equipment 1001 shown in FIGS. 24 and 25 includes a slide apparatus 2200 having a curved surface in a longitudinal direction. The slide apparatus 2200 takes a posture as if it would be tilted when the second body 1200a is opened without a separate tilting mechanism. The slide apparatus 2200 includes a guide member 2210 which is mounted on the upper surface of the first body 1100a, and a slide member 2220 which is attached to the bottom surface of the second body 1200a and is displaceable together with the second body 1200a.

Referring to FIGS. 24 through 27, the guide member 2210 has a very short length in a longitudinal direction, but its width is larger than the length thereof. The guiding part 2211 formed at the opposite edges of the guide member 2210 has a height which is gradually increasing in a forward, i.e., longitudinal direction. The guiding part 2211 is preferably formed in a curve, but it may be formed in a straight line because of its short length. It is preferable to manufacture the guiding part 2211 by applying a synthetic resin on a thin-metallic skeleton using an insert injection molding as described above. A link plate mounting part 2212 is installed at the central portion of the guide member 2210 through a rivet 2213. A link plate 2214 for pivotably supporting one end of an elastic mechanism 2240a is installed onto the link plate mounting part 2212. The link plate mounting part 2212 is provided with a guide ridge 2215 on the upper surface thereof, in which the guide ridge 2215 is inserted in an elongated hole 2223 formed at the central portion of the slide member 2220 to guide the slide movement of the slide member 2220. Furthermore, the guide ridge 2215 prevents the slide member 2220 from being swayed in a lateral, i.e., transverse direction. The link plate mounting part 2212 has a different thickness in a longitudinal direction. The guiding member 2210 constructed as above is mounted on the upper surface of the first body 1100a through a screw 1113.

The slide member 2220 in the present embodiment is constructed by joining a curved lower plate 2220a with a curved upper plate 2220b, and the elastic mechanism 2240a is located on the upper surface of the lower plate 2220a. The lower plate 2220a is formed with a slot 2221a along the opposite edges thereof, and has an elongated hole 2223 to receive the guide ridge 2215 at the central portion thereof. A fastening hole 2224 to be secured to the second body 1200a through a screw 1213 is formed adjacent to the slot 2221a. A coupling ridge 2225 for securing the upper plate 2220b is formed along the periphery of the fastening hole 2224. Formed between the elongated hole 2223 and one of the slots 2221a is an opening 2226 for allowing a flexible cable to be passed through.

The upper plate 2220b is provided with a reverse U-shaped cross-section part 2221b along the opposite edges, in which the cross-section part 2221b is attached to the opposite sides of the slot 2221a along the latter, thereby encompassing the slots 2221a to form the guided part 2221 in the form of a T-shaped groove. The opposite lower ends of cross-section part 2221b are bent outwardly, which is attached to the lower plate 2220a. A plurality of coupling holes 2226a is formed at the opposite portions near the cross-section part 2221b.

Between the opposite coupling holes 2226a there are provided a first aperture 2227a and a second aperture 2227b. The first aperture 2227a is formed of a closed loop, while the second aperture 2227b is in the form of an open loop, i.e., one of its sides is missing. The first aperture 2227a is provided with a support part 2228 for supporting the elastic mechanism, in which the support 2228 projects from one side of the first aperture 2227a toward the inner side thereof. The support 2228 is designed to pivotably support one end of the elastic mechanism 2240a. The support 2228 has a U-shaped cross-section, whose one end is secured to the lower plate 2220a by means of a spot welding or an electrical resistance welding or the like. If the lower plate 2220a and the upper plate 2220b are made from a synthetic resin, however, the support 2228 may be attached by a fusion welding.

The second aperture 2227b is provide with a guide rail 2229 along its opposite edges. A door member 2230 which is formed with a guided rail 2231 along the opposite edges thereof is displaceably mounted on the guide rail 2229. A support member 2232 for pivotably supporting one end of another elastic mechanism 2240b is placed on the upper surface of the door member 2230. The door member 2230 is designed to close the opening 2226 so that the inner portion of the apparatus cannot be seen when the opening of the lower plate 2220a is exposed toward the outside of the first body 2220a after the latter is opened over the certain distance. The slide member 2220 is installed at the bottom surface of the second body 1200a through screws 1213.

The slide apparatus 2200 preferably includes the elastic mechanism 2240a. One end of the elastic mechanism 2240a is pivotably coupled to the support part 2228, while the other end is pivotably connected to the link plate 2214. The elastic mechanism 2240b connected to the door member 2230 serves to move the latter depending upon the opening degree of the second body 1200a. Alternatively, the elastic mechanism 2240b may be replaced with another connecting member.

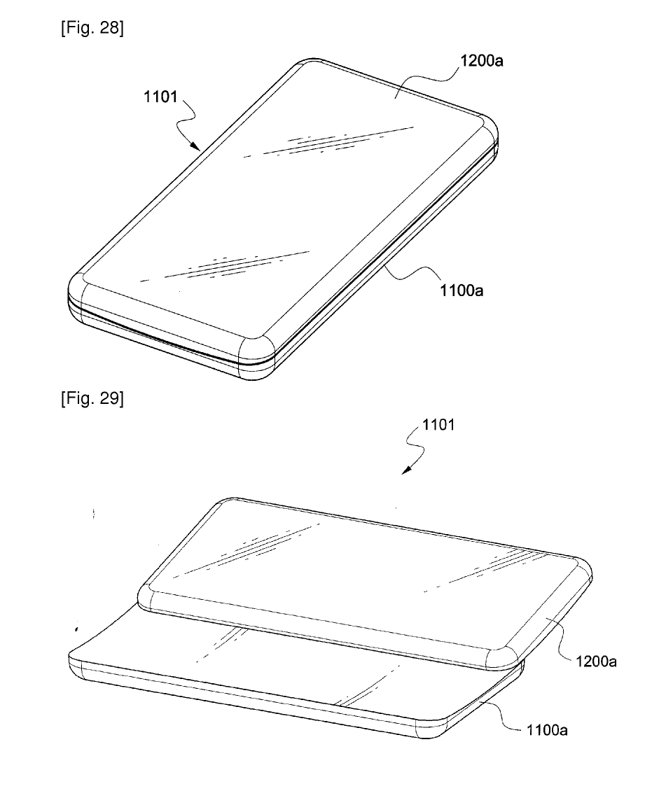

FIG. 28 is a perspective view illustrating the closed state of the slide type equipment, and FIG. 29 is a perspective view illustrating the state in which the second body of the slide type equipment is open.

Referring to FIG. 28, when the user pushes the second body 1200a in a forward direction while holding the slide type equipment 1101 with his or her hand, the guided part 2221 having a curved shape of the slide member 2220 described above displaces forward along the slanted guiding part 2211, in which the front side of the guided part may be raised in a state in that the second body 1200a is tilted at a certain angle on the first body 1100a as shown in FIG. 29. Here, one elastic mechanism 2240a is retracted and then expanded again to push forward the second body 1200a with its elastic force as the second body 1200a moves in the forward direction. In contrast, the other elastic mechanism 2240b supports the door member 2230, closing the opening 2226 of the lower plate 2220a when the second body 1200a is completely opened. The closing procedure of the second body 1200a is accomplished in a reverse order of its opening procedure described above.

The slide type equipment 1001 in the present embodiment does not require a separate tilting mechanism, and has less lateral sway since the guide ridge 2215 is guided in the elongated hole 2223 at the central portion thereof.

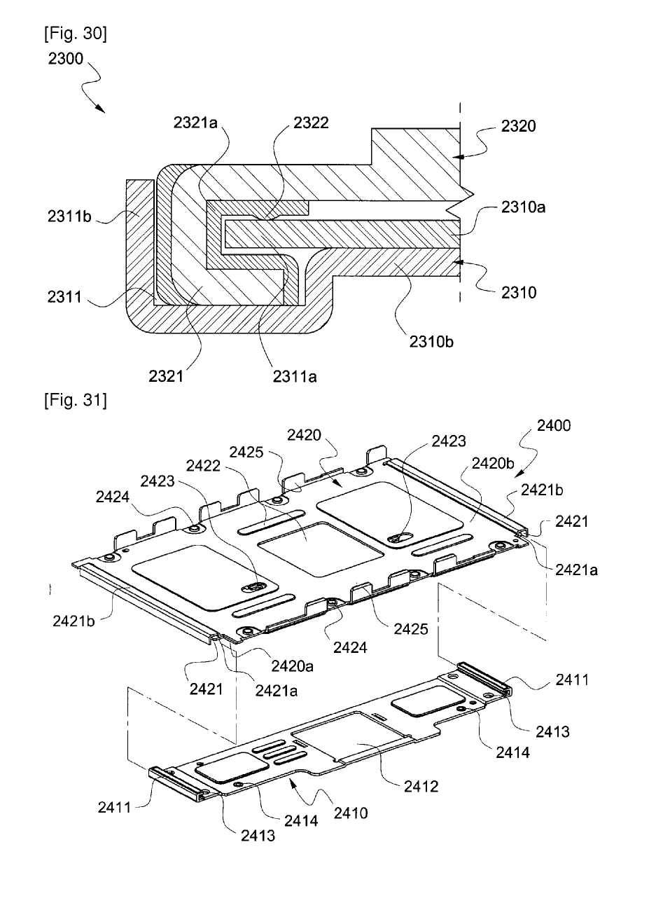

FIG. 30 is a partial sectional view illustrating the assembled slide type apparatus having an L-shaped guiding part and the guided part.

The slide apparatus 2300 shown in FIG. 30 includes a guide member 2310 and a slide member 2320. The upper plate 2310a and a lower plate 2310b both constituting the guide member 2310 are joined together to provide a guiding part 2311 in the form of an L-shaped groove. The straight rail part 2311a of the upper plate 2310a and the U-shaped bent part 2311b of the lower part 2310b form an L-shaped groove in the guiding part 2311. The guided part 2321 of the slide member 2320 is formed of a protrusion having an L-shaped cross-section. Attached on the inside and outside of the guided part 2321 is a sliding member 2321a with a synthetic resin or the like. The sliding member 2321a is preferably formed by an insert injection molding. In the alternative, the guided part 2321 may be provided with a member having an L-shaped cross-section, in which the member is inserted within the inner side of the guided part 2321. Further, the sliding member 2321a may be formed with a projection 2322 so as to reduce the contact area with the guide member 2310.

Referring to FIG. 30, the U-shaped bent part 2311b supports the bottom surface and outer side surface of the guided part 2321, thereby preventing the guided part 2310 from being flexed.

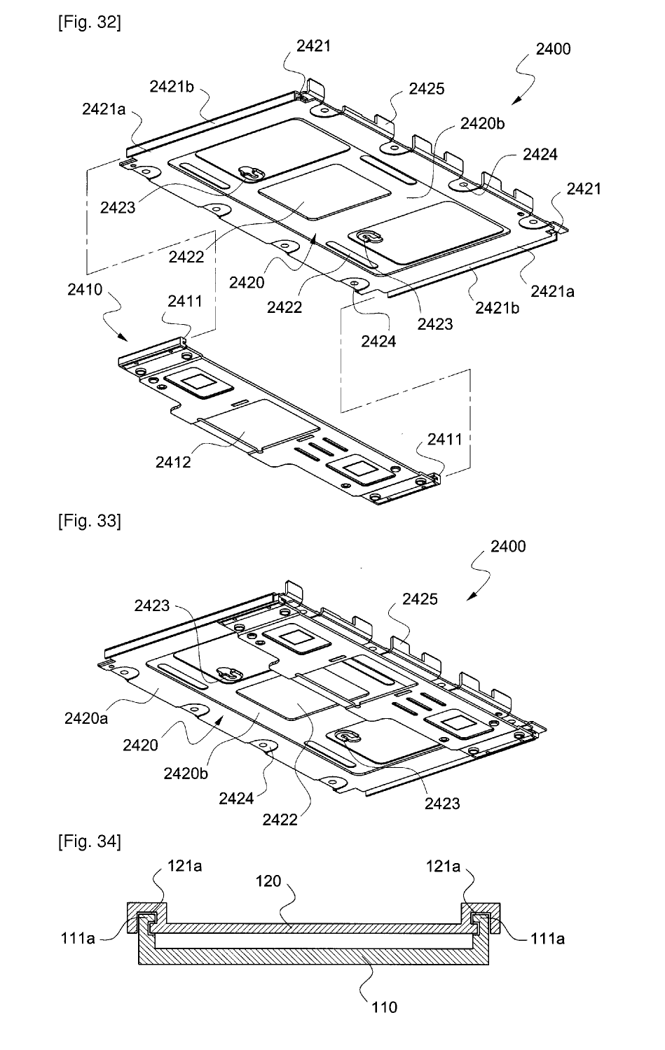

FIG. 31 is a separated perspective view illustrating another embodiment of the slide apparatus in accordance with the present invention. FIG. 32 is a separated perspective bottom view of FIG. 31, and FIG. 33 is a perspective view illustrating the assembled state of the slide apparatus of FIG. 32.

A slide apparatus 2400 shown in FIGS. 31 through 33 is provided with a slide member 2420. The slide member 2400 is formed with a large opening 2422 at the central portion thereof. The slide member 2420 includes a lower plate 2420a having a straight rail 2421a along the opposite edges thereof, and an upper plate 2420b having an opening 2422, an elastic mechanism support part 2423, and a plurality of fastening holes 2424, in which the upper plate 2420b is formed with a U-shaped bent part 2421b along the opposite edges thereof. The upper plate 2420b and the lower plate 2420a are joined together to constitute a slide member 2420. The straight rail 2421a cooperates with the U-shaped bent part 2421b to form an L-shaped cross-section, i.e., a guiding part 2421 in the form of an L-shaped groove. The upper plate 2420b is provided with a plurality of extensions 2425 bent upward at the longitudinal edges thereof.

The guiding member 2410 includes a guiding part 2411 having an L-shaped cross-section at its opposite edges. The guiding part 2411 is inserted in the guided part 2421 of the slide member 2420. It is desirable to form the guided part 2411 by applying a synthetic resin onto the surface of a metallic skeleton using an insert injection molding or the like. The guiding member 2410 includes an opening at the central portion, fastening holes 2413 at its four corners, and a pair of support holes 2414 for supporting one end of the elastic mechanism as needed.

In the description above, alternatively, it is possible to change the position of the guide member 2410 and the slide member 2420, in which the guide member serves to act as the slide member and vice versa.

The slide apparatus 2400 described above with reference to FIGS. 31 through 33 receives less damage or fracture even if a lateral force is applied between the guide member 2410 and the slide member 2420 since the guiding part 2411 and the guided part 2421 support them together at the opposite sides. Further, the slide member 2420 is not swayed in a lateral direction with respect to the guide member 2410. The U-shaped bent part 2421b of the guided part 2421 is to support the upper and side surface or the bottom and side surface of the guiding part 2411, which prevents the guiding part 2411 from being flexed to become a cause of malfunction of the slide apparatus 2400. Even if the roles of the guiding part 2411 and the guided part 2421 are changed with each other, they represent same advantageous effects.

It is preferable to install the elastic mechanism between the elastic mechanism support hole 2414 of the guide member 2410 and the elastic mechanism support part 2423 of the slide member 2420, so that the elastic force of the elastic mechanism can be applied in a longitudinal direction depending on the position of the slide member 2420.

FIG. 34 is a sectional view illustrating another embodiment of the guiding part and the guided part in accordance with the present invention. The guiding part 111a formed at the guide member 110 may be formed of a protrusion having an L-shaped cross-section, and the guided part 121a formed at the slide member 120 may be formed of a groove having an L-shaped cross-section, so that they are coupled to support each other at the opposite side thereof. In the FIG. 34, the guiding part 111a and the guided part 121a may be formed reversely by changing their position accordingly.

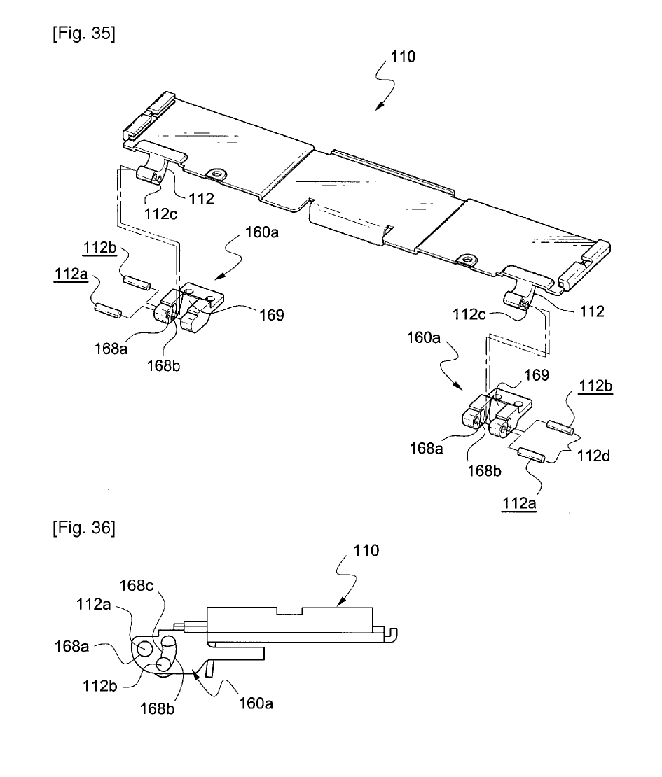

FIG. 35 is an exploded perspective view illustrating another embodiment of the tilting mechanism in accordance with the present invention, and FIG. 36 is a side elevation view illustrating the assembled state of the tilting mechanism.

The tilting mechanism shown in FIGS. 35 and 36 is designed to manually tilt a guide member without using a spring force.

The guide member 110 is formed with a pair of spaced apart hinge parts 112 having a curved bottom surface at one side edge thereof. The hinge part 112 has a pair of pin holes 112c spaced apart from each other, in which tilting guided parts 112a and 112b are inserted. A tilting guide member 160a is formed with a pair of tilting guide part 168a and 168b spaced apart from each other at the opposite sides to receive the respective tilting guided parts 112a and 112b therein, which may constitute a tilting mechanism. The tilting guide parts 168a and 168b serve to guide the tilting guided parts 112a and 112b to be pivotable and displaceable, so as to pivot and tilt the guide member 110. The tilting guide member 160a may be coupled with the first body or the like described hereinabove. Alternatively, the tilting guide member 160a may be integrally formed with the first body or the like.

Referring to FIGS. 35 and 36, the tilting guided parts 112a and 112b composing the pin 112d project from the opposite sides of the hinge part 112 to form a shaft shape necessary for a pivotal and displaceable movement. The tilting guide parts 168a and 168b are composed of grooves for guiding the pivotal and displaceable movement of the shaft according to the tilting operation of the guide member 110. One of the grooves constituting the tilting guide parts 168a and 168b is formed of a circle in order to pivotably support the tilting guided part 112a, while the other groove is formed of an elongated arc so as to allow the tilting guided part 112b to be guided along the circular arc path according to the tilting operation of the guide member 110. For such an arrangement the elongated arc should be longer in length than the diameter of the pin. The tilting guide member 160a is formed with a curved surface part 169 at the central portion thereof, in which the curved part 169 corresponds to the curved bottom surface of the hinge part 112. The curved surface part 169 guides the bottom surface of the hinge part 112, which allows the guide member 110 to be smoothly pivotable when tilted.

In the alternative, each of the tilting guide member 160a and the hinge part 112 is used only one at the center of the width direction of the guide member 110. However, it is preferable to install them in pairs spaced apart from each other as shown in FIG. 35.

Referring to FIG. 36, the arc-shaped tilting guide parts 168b is formed with a ridge 168c in the inner surface thereof, in which the ridge 168c is engaged with the outer surface of the tilting guided parts 112b to maintain the tilting angle of the latter. The ridge 168c may be formed at one location or at more than two locations in a multistaged fashion. Preferably, the ridge 168c may be formed at locations which correspond to the posture of the guide member 110 in a folded-state, a medium-tilted state, or a completely-tilted state, respectively.

When constructing the tilting mechanism as shown in FIGS. 35 and 36, it may be structurally simple and can pivot a member to be tilted such as the guide member 110 or the like at various angles.

In the embodiment shown in FIGS. 35 and 36, alternatively, the tilting guided parts 112a and 112b and tilting guide parts 168a and 168b may be installed reversely by changing their position, respectively. In other words, the hinge part 112 may be formed with a tilting guided part in the form of a groove, while the tilting guide member 160a may be formed with a tilting guide part in the form of a pin, which may also constitute a tilting mechanism. Such an alternative construction may be employed in the embodiments described hereinabove as well as hereinbelow.

In the alternative, a torsion spring may be installed on the outer surface or the like of the tilting guided part 112a, so as to utilize the elastic force of the torsion for a tilting operation.

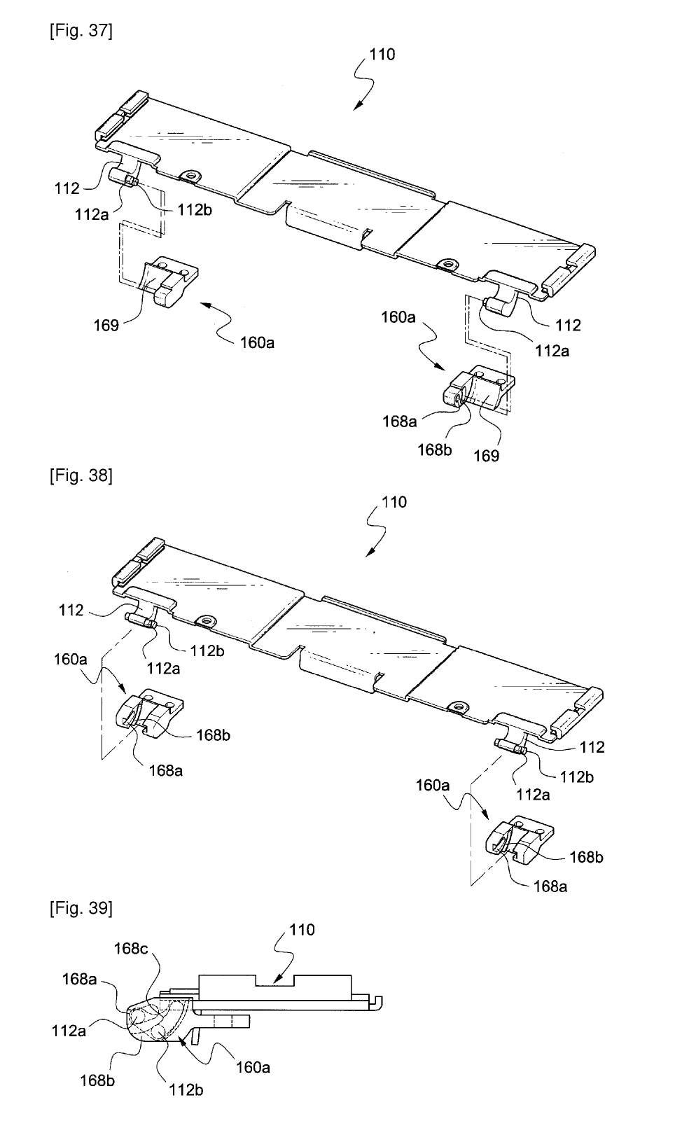

FIG. 37 is a separated perspective view illustrating a modified embodiment of the guide member shown in FIG. 35.

Referring to FIG. 37, a tilting mechanism may be constructed such that only one of the tilting guided parts 112a and 112b is formed at one side of each hinge part 112, and only one of the tilting guide parts 168a and 168b is provided at one side of each corresponding tilting guide member 160a. The rest of the structure of the guide member 110 is the same as described through FIGS. 35 and 36. With such construction above, the tilting guided parts 112a and 112b can be integrally formed with the hinge part 112, which makes it easy to assemble the guide member 110.

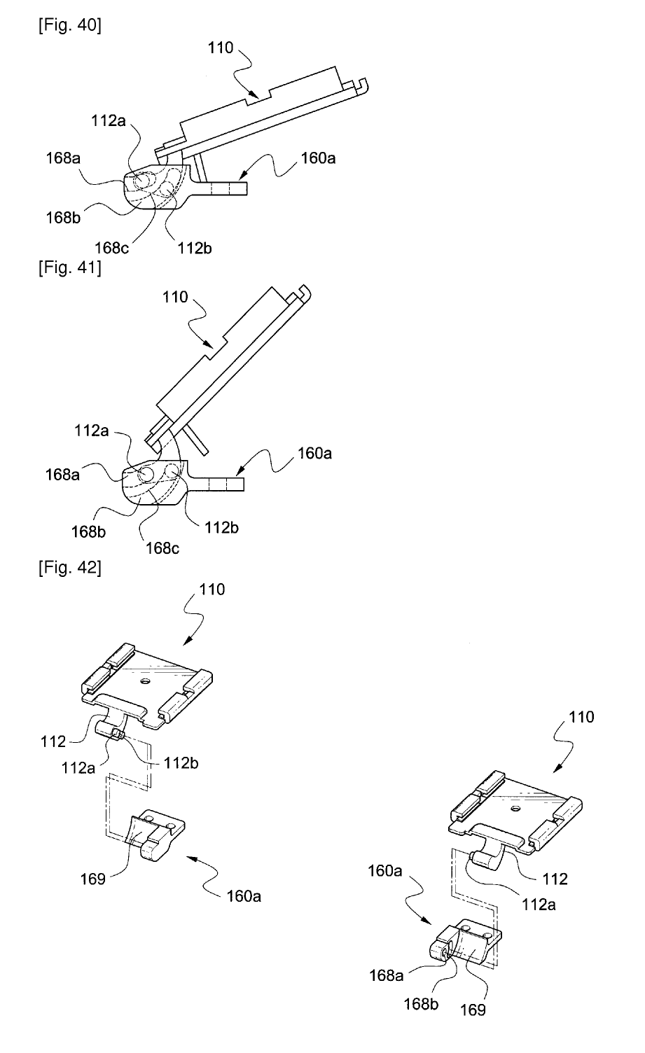

FIG. 38 is a separated perspective view illustrating another modified embodiment of the guide member shown in FIG. 35. FIGS. 39 through 41 are side elevation views each illustrating a folded state, a first tilted state, and a second tilted state of the tilting mechanism shown in FIG. 38.

Referring to FIG. 38, both tilting guide part 168a and 168b provided in the tilting guide member 160a may be formed of an elongated groove shape like a circular arc. Preferably, the tilting guide part 168a adjacent to a rotational center of tilting operation may be shorter in length than that of the tilting guide part 168b. In order to tilt the guide member 110, a pair of tilting guided parts 112a and 112b, which are projected at the opposite sides, may be guided in sequence within the tilting guide part 168a and 168b respectively as shown in FIGS. 39 through 41, which allows the guide member 110 to be tilted at a predetermined angle. In the initial state where the guide member is not yet tilted, the tilting guided parts 112b is positioned lower than the tilting guided parts 112a.

The tilting guide parts 168b is formed with a ridge 168c in the inner surface thereof, in which the ridge 168c is engaged with the outer surface of the tilting guided parts 112b at each operating state to allow the guide member 110 to maintain its posture in a stable manner. Preferably, the ridge 168c may be formed at locations which respectively correspond to the positions of the tilting guided parts 112b in a folded-state, a medium-tilted state, or a completely-tilted state of the guide member 110. This may be applied the tilting guide parts 168a.

In other words, in a state when the guide member 110 is not yet tilted, each tilting guided parts 112a and 112b is positioned at the lower end of the tilting guide parts 168a and 168b, respectively as shown in FIG. 39. As the guide member 110 gets tilted, each tilting guided parts 112a and 112b is displaced to the intermediate position of the tilting guide parts 168a and 168b, respectively, which makes the guide member 110 be tilted at an intermediate angle. When the guide member 110 is further pivoted upwardly, both tilting guided parts 112a and 112b are displaceably raised up to the upper end of the tilting guide parts 168a and 168b along the latter, in which the guide member 110 holds a completely tilted posture as shown in FIG. 41.

FIG. 42 is a separated perspective view illustrating another embodiment of the tilting mechanism in accordance with the present invention.

Referring to FIG. 42, a member to be tilted such as a guide member 110 may be separately arrangements. In other words, each guide member 110 includes a hinge part 112 having a tilting guided part 112a or 112b selectively. A tilting guide member 160a may be formed with a tilting guide part 168a or 168b which is correspondingly formed to the tilting guided part 112a or 112b, thereby constructing a tilting mechanism for the guide member 110, accordingly. The bottom surface of the hinge part 112 is preferably formed with a curved surface, and then the tilting guide member 160a is preferably formed with a curved surface part 169 corresponding to the curved surface of the hinge part 112.

In the case of application to slide type equipment having a large width, it is desirable to construct the guide member 110 in pairs as shown in FIG. 42. When the equipment has a narrow width or no difficulty with sway problems, the tilting mechanism may be constructed using only one guide member.

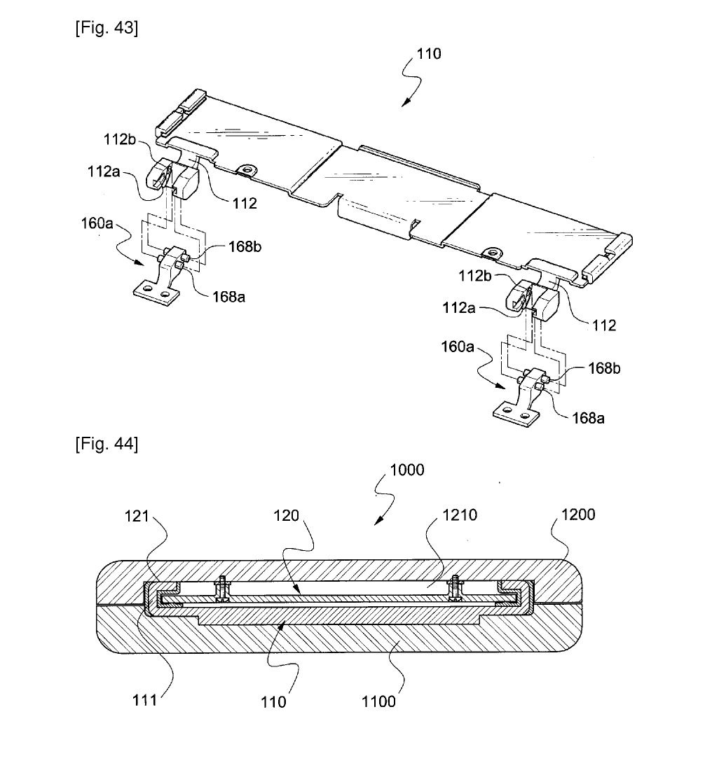

FIG. 43 is a separated perspective view illustrating a modified embodiment of the tilting mechanism shown in FIG. 38.

Referring to FIG. 43, both tilting guide parts 168a and 168b provided in the tilting guide member 160a may be formed of a shaft, and the tilting guided part 112a and 112b provided in the hinge part 112 may be formed in an elongated groove like a circular arc. When the guide member 110 is tilted, both the tilting guided part 112a and 112b are guided by the tilting guide parts 168a and 168b respectively, thereby allowing the guide member 110 to be tilted at a predetermined angle.

In a state when the guide member 110 is not yet tilted, the upper ends of the tilting guided parts 112a and 112b are engaged the tilting guide parts 168a and 168b, respectively. As the guide member 110 is tilted, each tilting guided parts 112a and 112b is guided and displaced to the medium and lower position, respectively, while maintaining its tilted state at a corresponding angle.

In the alternative, it is possible to interchangeably arrange the shape and position of the tilting guided parts and the tilting guide parts with each other, which will be similarly applied to the other embodiments described hereinabove.

FIG. 44 is a sectional view illustrating another modified embodiment of the slide type equipment shown in FIG. 38.

Referring to FIG. 44, the second body 1200 is formed with a groove 1210 for mounting a slide member 120, in which the slide member 120 is secured thereto through screws. A guided part 121 in the form of an L-shaped groove is provided at the opposite sides of the groove 1210, which may constitute a slide apparatus in accordance with the invention. The L-shaped guiding part 111 to which the guided part 121 is coupled and guided is formed along the opposite edges of the guide member 110. The guide member 110 is mounted on the first body 1100, while the slide member 120 is installed at the second body 1200.

Although several exemplary embodiments of the present invention have been described for illustrative purposes, those skilled in the art will appreciate that various modifications, additions and substitutions are possible, without departing from the scope and spirit of the invention as disclosed in the accompanying claims.

### INDUSTRIAL APPLICABILITY

The present invention may be suitably applied to a portable terminal which is closable and openable in a sliding manner. In particular, the present invention may be utilized in slide type equipment such as a portable game machine or the like having a large width used with both hands by the user, or in slide type equipment having a member provided with a display thereon, in which the member is slidably displaced and pivotably tilted in use.

1. A slide apparatus comprising:
a guide member on which at least a pair of guiding parts are spaced apart from each other; and
a slide member having at least a pair of guided parts coupled with the respective guiding parts so as not to be derailed in a direction perpendicular to the guide member and displaceable along the same, wherein the slide member is displaceable along the guide member, and
wherein the guiding part includes guide surfaces for guiding the opposite sides of the guided part.

2. The slide apparatus as recited in claim 1, wherein the guiding part is formed of a T-shaped protrusion and the guided part is in the form of a T-shaped groove, or the guiding part is formed of a T-shaped groove and the guided part is in the form of a T-shaped protrusion.

3. The slide apparatus as recited in claim 2, wherein the T-shaped groove is formed by attaching a member having a U-shaped cross-section with a member having a slot, wherein the U-shaped member has a larger width than that of the slot.

4. The slide apparatus as recited in claim 1, wherein the guiding part is formed of an L-shaped protrusion and the guided part is in the form of an L-shaped groove, or the guiding part is formed of an L-shaped groove and the guided part is in the form of an L-shaped protrusion.

5. The slide apparatus as recited in claim 4, wherein the L-shaped groove may be formed by attaching a member having a U-shaped bent part along its edge with a member having a straight rail along its edge, or the L-shaped groove may be formed by attaching a member having a straight rail with the body of equipment having a groove.

6. The slide apparatus as recited in claim 1, wherein the guiding part or the guided part is formed by applying a synthetic resin onto the surface of a metallic skeleton.

7. The slide apparatus as recited in claim 1, wherein the guiding part may have a different height in a longitudinal direction, and the slide member is formed in a curved shape in a longitudinal direction.

8. The slide apparatus as recited in claim 1, wherein the guide member is formed with a guide protrusion between the opposite guiding parts, and wherein the slide member is formed with an elongated hole in which the guide protrusion is inserted and guided in a longitudinal direction.

9. The slide apparatus as recited in claim 8, wherein the guide protrusion projects in the other side of the guide member through the elongated hole, wherein a link plate is installed on the guide protrusion, wherein one end of an elastic mechanism is pivotably connected to the link plate, and wherein the other end of an elastic mechanism is pivotably supported at one side of the slide member.

10. The slide apparatus as recited in claim 8, wherein the guide protrusion projects in the other side of the guide member through the elongated hole, wherein the link plate is installed on the guide protrusion, wherein an aperture is formed at one side of the elongated hole, wherein a guide rail is formed along the edge of the aperture, wherein a door member having a guided part along its opposite edges is movably installed in a longitudinal direction on the guide rail, and wherein the link plate and the door member are connected to each other through a member, whereby the door member is displaceable in a longitudinal direction along the guide rail as the slide member moves in a forward and reward direction.

11. The slide apparatus as recited in claim 1, wherein the guiding part or guided part is formed with a protrusion in order to reduce the contact area therebetween.

12. The slide apparatus as recited in claim 1, wherein a tilting mechanism is connected with the guide member for obliquely erecting or tilting the guide member depending on the position of the slide member.

13. The slide apparatus as recited in claim 12, wherein the tilting mechanism includes at least a pair of tilting guided parts spaced apart from each other formed at the guide member; and a tilting guide member having at least a pair of tilting guiding parts spaced apart from each other and directly or indirectly connected with the pair of tilting guided parts,
wherein the tilting guiding parts are designed to guide the pair of tilting guided parts, which allows the guide member to be pivoted and tilted,
wherein the tilting guided part is formed of a shaft a groove and the tilting guiding part is in the form of a groove or a shaft for guiding the pivotal and displaceable movement of the tilting guided part depending on the tilting operation of the guide member, and
wherein the tilting guiding part or tilting guided part composed of at least one groove is longer in its length than the diameter or thickness of the shaft-shaped tilting guided part or tilting guided part.

14. The slide apparatus as recited in claim 12, wherein one or more ridges, with which the shaft-shaped tilting guided part or tilting guiding part is coupled at a constant tilting angle, is formed on the inner surface of the tilting guiding part or tilting guided part which is composed of a groove.

15. The slide apparatus as recited in claim 12, wherein the tilting mechanism further includes a link member which indirectly connects the guide member with the tilting guiding part,
wherein one end of the link member is pivotably connected with the guide member, and the other end of the link member is pivotably connected with the tilting guide member, and
wherein at least one of the connecting portions between the guide member and the link member or between the link member and the tilting guide member is connected with each other so as to be displaceable in a predetermined distance.

16. The slide apparatus as recited in claim 1, further comprising an elastic mechanism to bias the slide member in a longitudinal direction depending on the position of the slide member, wherein one end of the elastic mechanism is pivotably connected with the guide member, while the other end of the elastic mechanism is pivotably connected with the slide member.

17. A tilting mechanism, comprising: a tilting guide member having the tilting mechanism includes at least a pair of tilting guided parts spaced apart from each other formed at a member for tilting; and a tilting guide member having at least a pair of tilting guiding parts spaced apart from each other and directly or indirectly connected with the pair of tilting guided parts, wherein the tilting guiding parts are designed to guide the pair of tilting guided parts, which makes the member to be tilted capable of being pivoted and tilted,
wherein the tilting guided part is formed of a shaft or a groove, and the tilting guiding part is a groove or a shaft for guiding the pivotal or displaceable movement of the tilting guided part depending on the tilting operation of the member to be tilted, and
wherein a groove consisting of at least one of the tilting guiding part or tilting guided part has a construction including a greater length than the diameter or thickness of the shaft-shaped tilting guided part or tilting guiding part.

18. The tilting mechanism as recited in claim 17, wherein one of the grooves consisting of the tilting guiding part or tilting guided part is formed of a circular groove which supports the shaft-shaped tilting guided part or tilting guiding part to be pivoted about the same, and the other groove is in the form of an elongated arc groove which is formed along the arc centered at the circular groove.

19. The tilting mechanism as recited in claim 17, wherein both grooves consisting of the tilting guiding part or tilting guided part have a greater length than the diameter or thickness of the shaft-shaped tilting guided part or tilting guided part so that both the shaft-shaped tilting guided part or tilting guided part can be displaced and tilted.

20. The tilting mechanism as recited in claim 17, wherein one or more ridges, with which the shaft-shaped tilting guided part or tilting guiding part can be coupled at a constant tilting angle, is formed in the inner surface of the groove consisting of the tilting guiding part or tilting guided part.

21. The tilting mechanism as recited in claim 17, further comprising a link member for indirectly connecting the member to be tilted with the tilting guiding part,
wherein one end of the link member is pivotably connected with the member to be tilted, and the other end of the link member is pivotably connected with the tilting guide member, and
wherein at least one of the connecting portions between the member to be tilted and the link member or between the link member and the tilting guide member is connected with each other so as to be displaceable in a predetermined distance.

22. The tilting mechanism as recited in claim 21, further comprising an elastic member for providing an elastic force in such a direction that one end of the link member is to be erected, wherein the elastic member is installed at least one or between two of the member for tilting, tilting guide member, link member and the shafts pivotably supporting thereof, thereby applying an elastic force in such a direction as to tilt the member for tilting.

23. The tilting mechanism as recited in claim 21, wherein the member for tilting is provided with a lift prohibiting member at the rear lower portion thereof, wherein the tilting guide member is formed with a lift prohibiting guide part which is coupled with the lift prohibiting member and allows the latter to be displaceable in a longitudinal direction, and wherein the rear end of the member for tilting is displaced in a forward direction to cause the guide member to be tilted and keep the rear end of the member for tilting from being lifted over a predetermined height.

24. The tilting mechanism as recited in claim 23, wherein the tilting guide member is provided with a ridge for adjusting the tilting angle of the member for tilting at one side of the tilting guide member in the moving path of the lift prohibiting member, wherein one side of the lift prohibiting member is engaged with the ridge.

25. A slide apparatus comprising:
a guide member having a guiding part;
a slide member having a guided part coupled with the guiding part so as not to be derailed in a direction perpendicular to the guiding part and displaceable along the same, wherein the slide member is displaceable along the guiding part; and
a tilting mechanism according to claim 17, wherein the tilting mechanism is connected with the guide member for folding or tilting the guide member.

26. A slide type equipment comprising:
a first body;
a second body; and
a slide apparatus according to claim 1, wherein one side of the slide apparatus is connected with the first body, and the other side of the slide apparatus is connected with the second body, thereby making it possible to slidably open and close the second body with respect to the first body.

27. A slide type equipment comprising:
a first body;
a second body; and
a slide apparatus according to claim 25, wherein one side of the slide apparatus is connected with the first body, and the other side of the slide apparatus is connected with the second body, thereby making it possible to tilt the second body with respect to the first body at a predetermined angle.
